(19) United States
(12) Patent Application Publication
(10) Pub. No.: US 2025/0123646 A1
(43) Pub. Date: Apr. 17, 2025

(54) LOW DROPOUT (LDO) REGULATOR

(71) Applicant: TEXAS INSTRUMENTS INCORPORATED, Dallas, TX (US)

(72) Inventors: Kang Wei, Plano, TX (US); Boqiang Xiao, Plano, TX (US); Timothy Merkin, Princeton, TX (US); Joseph Sankman, Fort Collins, CO (US)

(21) Appl. No.: 18/821,302

(22) Filed: Aug. 30, 2024

Related U.S. Application Data
(60) Provisional application No. 63/590,581, filed on Oct. 16, 2023.
(60) Provisional application No. 63/590,564, filed on Oct. 16, 2023.
(60) Provisional application No. 63/590,548, filed on Oct. 16, 2023.

(51) Int. Cl. G05F 1/575; G05F 1/563; G05F 1/595; H02M 3/07

(52) U.S. Cl. CPC G05F 1/575; G05F 1/563; G05F 1/595; H02M 3/07

(57) ABSTRACT

An integrated circuit includes a first transistor coupled between a power input and a power output, the first transistor being an N-type transistor and having a first transistor control input; a first amplifier stage having a reference input, a feedback input, and a first amplifier output, the feedback input coupled to the power output; a second amplifier stage having an amplifier input and a second amplifier output, the amplifier input coupled to the first amplifier output, and the second amplifier output coupled to the first transistor control input; and a first biasing circuit coupled to the first transistor control input, the first biasing circuit having an electrical control input coupled to the power output.

### CROSS-REFERENCE TO RELATED APPLICATION

This application claims the benefit of and priority to: (i) U.S. Provisional Application No. 63/590,548, filed Oct. 16, 2023, entitled “Split Biasing for Quiescent Current Reduction in Low Dropout (LDO) Regulator;” (ii) U.S. Provisional Application No. 63/590,564, filed Oct. 16, 2023, entitled “Dual-Loop Load Dependent Miller Compensation for Low Dropout (LDO) Regulator;” and (iii) U.S. Provisional Application No. 63/590,581, filed Oct. 16, 2023, entitled “Fast Load Transient Technique for Low Dropout (LDO) regulator,” each of which is assigned to the assignee hereof and is hereby incorporated by reference in its entirety for all purposes.

### BACKGROUND

Low dropout (LDO) regulators can be used to generate an output voltage from an input voltage (e.g., a supply voltage), and regulate the output voltage at a target value. LDO regulators may provide a relatively stable, load-independent output voltage that is close to the input voltage (and thus having a low dropout). For example, LDO regulators may be used in mobile devices or other battery-powered electronic devices to maintain the target system voltage level independently of the charging state of the battery. LDO regulators may also be used in a system-on-a-chip (SOC) for local on-chip voltage regulation.

An LDO regulator can have a relatively simple structure. For example, an LDO regulator may include a reference, a feedback amplifier that amplifies the difference between the reference and the regulator output (or a scaled-down version of the regulator output), and a pass element (e.g., a pass transistor) between the input voltage and the output voltage. The pass element may be controlled by the output of the amplifier to achieve the target output voltage. Compared with other types of voltage regulator, such as switching voltage regulators, LDO regulators can have fast transient response, low noise (e.g., no switching noise), design simplicity (including fewer components), and smaller device size (e.g., because no inductors or transformers are needed and fewer components are used). But LDO regulators may dissipate heat, and may have a relatively high loss and a relatively low efficiency. It may also be challenging for LDO regulators to achieve good dynamic performance, stability, and power supply rejection ratio (PSRR) at both low and high load current.

### SUMMARY

This summary is provided to introduce examples of disclosed concepts in a simplified form, which are further described below in the Detailed Description including the drawings provided.

According to certain aspects, an apparatus may include a first transistor coupled between a power input and a power output, the first transistor being an N-type transistor and having a first transistor control input; a first amplifier stage having a reference input, a feedback input, and a first amplifier output, the feedback input coupled to the power output; a second amplifier stage having an amplifier input and a second amplifier output, the amplifier input coupled to the first amplifier output, and the second amplifier output coupled to the first transistor control input; and a first biasing circuit coupled to the first transistor control input, the first biasing circuit having an electrical control input coupled to the power output.

According to certain aspects, an apparatus may include a first transistor coupled between a power input and a power output, the first transistor being an N-type transistor and having a first transistor control input; a first amplifier stage having a reference input, a feedback input, and a first amplifier output, the feedback input coupled to the power output; a second amplifier stage having an amplifier input and a second amplifier output, the amplifier input coupled to the first amplifier output, and the second amplifier output coupled to the first transistor control input; and a capacitor and a second transistor coupled in series between the first amplifier output and the first transistor control input, the second transistor having a second transistor control input electrically coupled to the power output and the first amplifier output.

According to certain aspects, an apparatus may include a transistor coupled between a power input and a power output, the transistor being an N-type transistor and having a transistor control input; an amplifier having a reference input, a feedback input, and an amplifier output, the feedback input coupled to the power output; a buffer having a buffer input, a bias input, and a buffer output, the buffer input coupled to the amplifier output; a level shifter having a level shifter input and a level shifter output, the level shifter input coupled to buffer output, and the level shifter output coupled to the transistor control input; a first biasing circuit coupled between the power input and the bias input of the buffer; and a second biasing circuit coupled to the level shifter output and the transistor control input.

The foregoing summary outlines rather broadly various features of examples of the present disclosure so that the following detailed description may be better understood. Additional features and advantages of such examples will be described hereinafter. This summary is neither intended to identify key or essential features of the claimed subject matters, nor is it intended to be used in isolation to determine the scope of the claimed subject matters. The subject matters should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1 is a schematic of an example of a low-dropout (LDO) regulator with an N-type field effect transistor (NFET) as a pass device.

FIG. 2 is a schematic of an example of an LDO regulator with an NFET as a pass device and including a dynamic biasing circuit.

FIG. 3 is a schematic of an example of the LDO regulator of FIG. 2.

FIG. 4 is a schematic of an example of an LDO regulator with an NFET as a pass device and including split biasing circuits.

FIG. 5 is a schematic of an example of the LDO regulator of FIG. 4.

FIG. 6 is a schematic of an example of an LDO regulator with an NFET as a pass device and including split biasing circuits.

FIGS. 7A and 7B include graphs showing examples of simulation results for LDO regulators with and without dynamic biasing circuit as described herein.

FIGS. 8A and 8B show examples of simulation results for LDO regulators with and without examples of dynamic biasing circuit as described herein.

FIGS. 9A and 9B show examples of simulation results for LDO regulators with and without split biasing circuits as described herein.

FIG. 10 is a schematic of an example of an LDO regulator with an NFET as a pass device and including an adjustable Miller compensation resistor.

FIG. 11 is a schematic of an example of the LDO regulator of FIG. 10.

FIG. 12 is a schematic of an example of the LDO regulators of FIGS. 10 and 11.

FIGS. 13A and 13B are graphs showing examples of simulation results for LDO regulators with and without the examples of adjustable Miller compensation resistor as described herein.

FIGS. 14A and 14B are graphs showing examples of simulation results for LDO regulators with and without the examples of adjustable Miller compensation resistor as described herein.

FIG. 15 is a schematic of an example of an LDO regulator incorporating various combinations of techniques as described herein.

The drawings and accompanying detailed description are provided for understanding of features of various examples and do not limit the scope of the appended claims. The examples illustrated in the drawings and described in the accompanying detailed description may be readily utilized as a basis for modifying or designing other examples that are within the scope of the appended claims. One skilled in the art will readily recognize from the following description that alternative embodiments of the structures and methods illustrated may be employed without departing from the principles, or benefits touted, of this disclosure. Identical reference numerals may be used, where possible, to designate identical elements that are common among drawings. The figures are drawn to clearly illustrate the relevant elements or features and are not necessarily drawn to scale.

### DETAILED DESCRIPTION

The present disclosure relates generally to low dropout (LDO) regulators. In some examples, an LDO regulator may include (1) a feedback loop to control a dynamic biasing circuit to improve the load transient response, (2) split biasing circuits to provide a large bias current from the input voltage and a relatively small bias current through a voltage boost circuit (e.g., a charge pump), (3) a feedback loop for load-dependent Miller compensation to control the resistance of the Miller compensation resistor using a voltage signal that tracks both the load current and the output voltage of the first amplifier stage, or any combination of these features to achieve a small device area, low quiescent current, fast response to load transient, low complexity, low current from charge pump, high power supply rejection ratio, low output noise, and low sensitivity to variations in process and operating conditions.

An LDO regulator may include a pass element (e.g., a pass transistor) that receives an input voltage and provides an output voltage. The LDO regulator may also include an amplifier that compares the output voltage (or a scaled version of it) with a reference voltage and generates a control signal for the pass element based on the difference between the output voltage and the reference voltage. The LDO regulator can set the control signal based on a difference between output voltage (or a scaled version) and the reference voltage, thereby regulating the output voltage. The pass element may include, for example, an NPN or PNP bipolar transistor, or an N-type or a P-type field effect transistor (FET). An LDO regulator may generally perform step-down voltage regulation operations, where the output voltage is lower than the input voltage. The voltage drop on the pass element may be controlled, by the control signal output by the amplifier, to regulate the output voltage at a target value. For example, in an LDO regulator having an NFET pass device, when the load current increases and thus the output voltage decreases, the difference between the output voltage and the target value increases, and thus the amplifier can increase the gate voltage of the NFET pass transistor to increase the drain current of the NFET transistor, which can increase the output voltage back to around the target value.

The amplifier of an LDO regulator may include, for example, a first amplifier stage and a second amplifier stage. The first amplifier stage may include a differential amplifier that can amplify the difference between the reference voltage and the output voltage (or a scaled-down version of the output voltage) of the LDO regulator. The second amplifier stage may include, for example, a buffer that may isolate the gate of the pass transistor and the output of the first amplifier stage, such that the pole at the gate of the pass transistor (e.g., a non-dominant pole) and the pole at the output of the first amplifier stage (e.g., the dominant pole) may be separated, and thus the LDO regulator can have a high unity gain frequency (UGF) and can be stable at a higher frequency for fast transient response. A large bias current for the second amplifier stage can increase the transconductance of the second amplifier stage, thereby pushing the pole at the gate of the pass transistor to a higher frequency for a fast dynamic/transient response and a high power supply rejection ratio (PSRR).

Therefore, compared with other types of voltage regulator, such as switching voltage regulators, LDO regulators can have fast transient response, low noise (e.g., no switching noise), design simplicity (including fewer components), and smaller device size (e.g., because no inductive components are needed and fewer components are used). However, in LDO regulators, the pass transistor is always on during the normal operations (e.g., steady-state operations), and the pass transistor may consume power (e.g., converting some input power into heat) due to the pass transistor having non-zero resistance. The control circuits (e.g., the amplifier) may also conduct a quiescent current to regulate the output voltage (e.g., by charging or discharging the gate of the pass transistor). In some applications, the quiescent current may have a significant impact on the current efficiency (e.g., a ratio between the output current and a sum of the output current and the quiescent current). Thus, some LDO regulators may have a high quiescent current and a low current efficiency. It can be difficult to design LDO regulators with good dynamic performance, current efficiency, stability, and power supply rejection ratio (PSRR) at both low and high load current.

One way to reduce the quiescent current and improve the current efficiency of an LDO regulator is to reduce the bias current for biasing the second and/or first stages of the amplifier and the current for charging the gate capacitor of the pass transistor. For example, due to the higher mobility of the majority carrier (e.g., electrons), an NFET pass transistor may have a smaller area compared with a PFET pass transistor that has similar current drive capability, and thus may be used in an LDO regulator to reduce the size of the LDO regulator. The smaller pass transistor may have a smaller gate capacitance, and thus the gate capacitor can be charged at a high rate and/or with a smaller current. As such, the quiescent current for controlling the gate voltage of the pass transistor to set the output voltage may be reduced, and thus the current efficiency of the LDO regulator may be improved. Furthermore, reducing the gate capacitance may help to push the non-dominant pole at the gate of the pass transistor to a higher frequency or can maintain the frequency of the non-dominant pole with reduced bias current.

However, in NFET pass transistor-based LDO regulators, a voltage boost circuit (e.g., a charge pump or bootstrap circuit) may be included in order to charge the parasitic gate capacitor of the pass transistor and bias the second amplifier stage (e.g., a buffer), so that the voltage level at the gate of the pass transistor can be at higher than the input voltage of the voltage regulator, Such arrangement allows a voltage difference between the gate and the output terminal (e.g., the source) of the pass transistor to exceed a threshold, including in the case where the output voltage is close to the input voltage, to maintain the pass transistor in the on state. In order to boost the output voltage, the input current of a charge pump may be multiple times of the output current of the charge pump. In addition, the charge pump may consume power to operate and thus may increase the quiescent current of the LDO regulator. For example, some charge pumps may have relatively low efficiencies, such as at less than 50%. Thus, the charge pump may increase the quiescent power consumption. In addition, the size of the charge pump and/or the biasing circuit may be large to provide a bias current, in order to improve the transient performance of the LDO regulator. As such, it may be desirable to reduce the bias current from the charge pump for charging the gate capacitor and biasing the second amplifier stage, while achieving good load transient response performance.

In some examples, an LDO regulator may include an additional feedback loop (in addition to the feedback loop that feeds the output voltage) to control a dynamic biasing circuit to improve load transient response of the LDO regulator. The dynamic biasing circuit may consume no (or very little) quiescent current and thus may consume no power (or very little power) during steady-state operations of the LDO regulator, and thus may not significantly increase the quiescent power consumption of the LDO regulator. The dynamic biasing circuit may be turned on when the output voltage is lower than the target output voltage, to supply current to the gate of the pass transistor to pull up the gate voltage and thus the output voltage (e.g., at the source) of the pass transistor. When the output voltage becomes higher than the target output voltage, the output voltage of the first amplifier stage and the control voltage of the second amplifier stage may increase, such that the current flowing from the gate of the pass transistor through the second amplifier stage to ground may be increased to discharge the gate capacitor, thereby reducing the output voltage at the pass transistor. The dynamic biasing circuit may include a high-pass filter (HPF) that may pass high frequency variations of the output voltage to the amplifier directly (e.g., without being scaled down) to turn on the dynamic biasing circuit. Therefore, the LDO regulator can have good load transient performance. The additional feedback loop can have a low gain and a high bandwidth to improve load transient response, and may have minimum or no impact on the stability of the main feedback loop of the LDO regulator. The dynamic biasing circuit supplies zero current to the main feedback loop during steady state and the additional feedback loop may have a low quiescent current, and thus the additional circuit would not increase the quiescent current significantly during steady state operations of the LDO regulator.

As described above, some LDO regulators may use a large bias current for the second amplifier stage to increase the transconductance of the second amplifier stage, thereby reducing the transconductance of the second amplifier stage and pushing the pole (e.g., the non-dominant pole) at the gate of the pass transistor (and the output of the second amplifier stage) to a high frequency for fast dynamic response, high PSRR, and better stability. If all bias current for the second amplifier stage is provided by the charge pump, the total quiescent current may increase significantly due to the voltage up-conversion and limited conversion efficiency of the charge pump. Therefore, the current efficiency of the LDO regulator may be low, and the area of the charge pump for providing the large bias current may need to be increased.

In some examples, an LDO regulator may use a split biasing technique to provide a large bias current from the input voltage to the second amplifier stage that separates the gate of the pass transistor from the output of the first amplifier stage, and to provide a small bias current through a voltage boost circuit (e.g., a charge pump or a bootstrap circuit) to a level shifter and the gate of the pass transistor. The large bias current to the second amplifier stage from the input voltage can increase the transconductance of the second amplifier stage and thus the frequency of the non-dominant pole at the gate of the pass transistor, thereby increasing the operational bandwidth and improving the transient response and PSRR performance of the LDO regulator. The level shifter may be driven by the output of the charge pump and may shift the output voltage of the second amplifier stage to a higher level to drive the gate of the pass transistor, such that the output voltage of the LDO regulator may be closer to the input voltage. The level shifter may also help to isolate the gate of the pass transistor from input voltage to reduce noise in the output voltage. In this way, the current supplied by the charge pump may be reduced, and the quiescent power consumption and size of the LDO regulator may be reduced.

In some LDO regulators, Miller compensation may be used to improve the stability of the LDO regulator. A capacitor may be used in the Miller compensation circuit to increase the capacitance at the output of the first amplifier stage, which may have a high output impedance, and thus the dominant pole at the output of the first amplifier stage may have a low frequency and may be separated from non-dominant poles at higher frequencies. The Miller compensation circuit may also include a resistor to move a right-half plane (RHP) zero to the left-half plane (LHP), which may help to negate the effect of the non-dominant poles and increase the unity gain frequency and improve the phase margin. The non-dominant poles may be at different frequencies under different operating conditions. For example, when the load current is high, the transconductance of the pass transistor may be high, and thus a non-dominant pole at the output of the LDO regulator may move to a higher frequency. When the load current is low, the transconductance of the pass transistor may be low, and thus the non-dominant pole at the output of the LDO regulator may move to a lower frequency. Thus, it may be desirable to move the LHP zero with the non-dominant pole, in particular, when the load current is low, in order to improve the stability and unity gain frequency of the LDO regulator.

In some examples, a load-dependent Miller compensation loop that utilizes a current sensor, a current-to-voltage converter, and a voltage-controlled variable resistor may be used to track the load current and move the LHP zero accordingly by tuning the resistance of the variable resistor in the compensation circuit. At a high load current, since the non-dominant pole may move to high frequency and the unity gain frequency may increase, the variable resistor may be controlled to reduce the resistance, thereby moving the LHP zero to a higher frequency as well. At a low load current, the variable resistor may be controlled to increase the resistance, thereby moving the LHP zero to a lower frequency to negate the effect of a non-dominant pole at the output of the LDO regulator. But this loop may be in conflict with the main feedback loop of the LDO regulator in adjusting the gate voltage of the pass transistor, and thus may degrade the load transient response of the LDO regulator. In addition, the LHP zero may not be linearly proportional to the load current and may be sensitive to process, voltage, and temperature variations.

To overcome these issues in the load-dependent Miller compensation loop, an LDO regulator may include a variable Miller compensation resistor that is controlled based on the load current and output voltage, and a load-dependent Miller compensation loop that includes two loops. The first loop may include a load current sensing circuit and a current-to-voltage conversion circuit to set a voltage that tracks the load current. The second loop may include an amplifier to set the control voltage (e.g., gate voltage) of the Miller compensation resistor based on a difference between the output of the first amplifier stage (which may be associated with the output voltage of the LDO regulator) and the voltage that is set by the first loop to track the load current, such that the control voltage of the Miller compensation resistor may track both the load current and the output of the first amplifier stage (and thus the output voltage of LDO regulator). Therefore, the second loop may reconcile the conflicts between the opposite manners in which the main feedback loop and the first loop of the load-dependent Miller compensation loop control the gate voltage of the pass transistor in response to load transient, and thus can prevent the load-dependent Miller compensation loop and the main feedback loop from changing the gate voltage of the pass transistor in opposite directions, thereby improving the load transient response. This technique may also provide a more precise load-dependent zero that may be proportional to the load current, and may be insensitive to variations in the process and operational conditions, and can be implemented using natural MOS device, which may either use fewer masks than low threshold voltage MOS devices or share masks with other devices in common processes, thereby reducing mask cost.

In some examples, an LDO regulator may include various combinations of the techniques disclosed herein, including the output voltage controlled dynamic biasing circuit, split biasing circuits for reducing charge pump current and/or increasing bias current directly from input voltage, and additional loop for load-dependent Miller compensation to control the resistance of the Miller compensation resistor using a voltage signal that tracks both the load current and the output voltage of the first amplifier stage (and thus the output voltage of the LDO regulator). As such, LDO regulators disclosed herein may have small device area, low quiescent current, fast response to load transient, low complexity, low current from charge pump, high PSRR and low output noise, and may be less sensitive to variations in process and operating conditions.

Various features are described hereinafter with reference to the figures. An illustrated example may not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

Various examples are described herein. Although the specific examples may illustrate various aspects of the above generally described features, examples may incorporate any combination of the above generally described features (which are described in more detail in examples below). Three dimensional x-y-z axes are illustrated in some figures for case of reference. Some cross-sectional views of various semiconductor devices herein may be general depictions to illustrate various aspects or concepts concerning such semiconductor devices. More specifically, some drain contact structures illustrated in cross-sectional views may not necessarily accurately depict a structure of such drain contact contacts, except to the extent described herein. The illustrations of those drain contact structures are to illustrate various aspects or concepts concerning those drain contact structures.

In the following description, for the purposes of explanation, specific details are set forth in order to provide a thorough understanding of examples of the disclosure. However, it will be apparent that various examples may be practiced without these specific details. For example, devices, systems, structures, assemblies, integrated circuits, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

A low dropout (LDO) regulator may be used in an electronic circuit (e.g., an integrated circuit) to provide a stable local output voltage that may be close to the input voltage. Compared with other types of voltage regulator, such as switching voltage regulators, LDO regulators can have fast transient response, no switching noise, design simplicity (including fewer components), and smaller device size (e.g., because no inductive component is used and fewer components are used). An LDO regulator may include an amplifier that amplifies the difference between a reference and the regulator out (or a scaled-down version of the regulator output), and a pass element (e.g., a pass transistor) between the input voltage and the output voltage and controlled by the output of the amplifier. The pass element may include, for example, an NPN or PNP bipolar transistor, or an NFET or PFET FET. The voltage drop on the pass element may be controlled by the output of the amplifier to maintain the output at the target value. For example, in an LDO regulator having an NFET pass transistor, when the load current increases and thus the output voltage decreases, the voltage error and thus the amplifier output may increase, such that the control voltage (e.g., gate voltage) of the NFET pass transistor may increase, and thus the drain current of the NFET pass transistor may increase and the output voltage may return to the target value.

As described above, in an LDO regulator, the pass transistor may be always on (e.g., in linear operation mode) during the normal operations (e.g., steady-state operations), and thus may consume power (e.g., due to non-zero resistance of the pass transistor) in order to regulate the output voltage, in particular, when the voltage drop across the pass transistor is large and the output load current is high. In addition, the LDO regulator may consume quiescent current to control the pass transistor (e.g., by charging or discharging the gate of the pass transistor). In some applications, the quiescent current may have a significant impact on the current efficiency. Thus, some LDO regulators may have a high quiescent current and a low current efficiency. It can be difficult to design LDO regulators with good dynamic performance, efficiency, stability, and power supply rejection ratio (PSRR) at both low and high load current.

One way to reduce the quiescent current and improve the current efficiency of an LDO regulator is to reduce the bias current for biasing the second and/or first stages of the amplifier and the current for charging the gate capacitor of the pass transistor. For example, due to the higher mobility of the majority carrier (e.g., electrons), an NFET pass transistor may have a smaller area compare with a PFET pass transistor that has similar current drive capability, and thus may be used in an LDO regulator to reduce the size of the LDO regulator. The smaller pass transistor may have a smaller gate capacitance, and thus the gate capacitor can be charged at a high rate and/or with a smaller current. As such, the quiescent current for controlling the gate voltage of the pass transistor to stabilize the output voltage may be reduced. Furthermore, reducing the gate capacitance may help to push the non-dominant pole at the gate of the pass transistor to a higher frequency or can maintain the frequency of the non-dominant pole with reduced bias current.

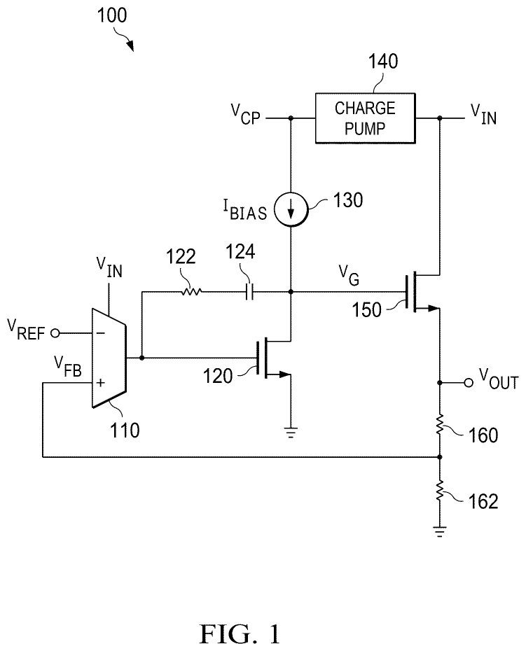

FIG. 1 is a schematic of an example of an LDO regulator 100. In the illustrated example, LDO regulator 100 may include a pass transistor 150, which is an N-type transistor such as an NFET or an NPN, an amplifier that may include a first amplifier stage 110 and a second amplifier stage 120. Second amplifier stage 120 may include an N-type transistor configured as a common-source amplifier (as shown) or a common-emitter amplifier. LDO regulator 100 may also include a Miller compensation circuit that may include a resistor 122 and a capacitor 124, and an output feedback scaling circuit that may include a resistor 160 and a resistor 162. The output feedback scaling circuit, the amplifier, and the Miller compensation circuit may form a main feedback loop for controlling pass transistor 150.

Pass transistor 150 may include an NFET transistor that has a drain coupled to an input voltage V_{IN}, a source coupled to a voltage output port of LDO regulator 100, and a gate coupled to the output of second amplifier stage 120. Thus, pass transistor 150 may be controlled by the amplifier to regulator the output voltage of LDO regulator 100. Due to the higher mobility of the majority carrier (e.g., electrons), the NFET pass transistor 150 may have a smaller area compare with a PFET pass transistor that has similar current drive capability, and thus LDO regulator 100 having the NFET pass transistor 150 may have a smaller sizer compared with a PFET-based LDO regulator. The smaller pass transistor 150 may have a smaller gate capacitance, and thus the gate can be charged at a high rate and/or with a smaller current. The voltage level of the output voltage may depend on the voltage level of input voltage V_{IN}, the voltage level at the gate (gate voltage V_{G}), and the threshold voltage V_{T} of pass transistor 150. When the voltage level at the gate is higher than the input voltage, for example, when the difference between gate voltage V_{G} and the input voltage V_{IN} is greater than the threshold voltage V_{T} of pass transistor 150, the pass transistor 150 is turned on, and the output voltage V_{OUT} of LDO regulator 100 may be close to input voltage V_{IN}.

In order to have a voltage level at the gate (V_{G}) of pass transistor 150 greater than the input voltage V_{IN}, a charge pump 140 or another voltage boost circuit (e.g., a bootstrap circuit) may be used to generate an output voltage V_{CP} that is higher than the input voltage V_{IN}, and the gate voltage of pass transistor 150 may then be set using voltage V_{CP}. Charge pump 140 may receive input from input voltage V_{IN}, and may store the energy (e.g., using capacitors) to provide the output voltage V_{CP} that is higher than input voltage V_{IN}, but the output current of charge pump 140 may be lower than the input current used to provide energy to charge pump 140. For example, if the voltage conversion ratio of a charge pump is 4, an input current more than 4 μA may be used to provide an output current of 1 μA from the charge pump. The charge pump may have an efficiency lower than 100%, such as lower than 50%, about 50%, about 60%, or up to about 90-95%. Thus, an input current much more than 4 μA (e.g., 8 μA if the efficiency of the charge pump is 50%) may be used to provide an output current of 1 μA from the charge pump. As shown in FIG. 1, the output voltage V_{CP} of charge pump 140 may be used to drive a biasing circuit 130 (e.g., a current source) to set the voltage level at the gate of pass transistor 150. The output of charge pump 140 may also be used to bias the second amplifier stage 120, the output of which is coupled to the gate of pass transistor 150.

The amplifier may drive the pass transistor based on a difference between a feedback voltage V_{FB} and a reference voltage V_{REF} to regulate the output voltage V_{OUT}. The reference voltage may be from, for example, a bandgap voltage reference. The feedback voltage V_{FB} may be a scaled down version of the output voltage V_{OUT}. The values of resistors 160 and 162 may be selected to set the desired voltage dividing ratio of the voltage divider formed by resistors 160 and 162 to generate a desired feedback voltage V_{FB}. First amplifier stage 110 may include a differential amplifier that receives, for example, input voltage V_{IN}, as a supply voltage, and may amplify the difference between the feedback voltage V_{FB} and the reference voltage V_{REF}. The output of first amplifier stage 110 may be input to the second amplifier stage 120, which may perform the voltage level shifting between the output of first amplifier stage 110 and the gate of pass transistor 150. In the illustrated example, second amplifier stage 120 may include a common-source amplifier formed by an NFET transistor. The gate of the NFET transistor of the second amplifier stage 120 may be coupled to the output of first amplifier stage 110, the source of the NFET transistor may be coupled to ground, whereas the drain of the NFET transistor may be coupled to biasing circuit 130 and the gate of pass transistor 150. Second amplifier stage 120 may function as a buffer to isolate the output of first amplifier stage 110 and the gate of pass transistor 150, such that a pole at the gate of pass transistor 150 and a pole at the output of first amplifier stage 110 may be separate. Therefore, LDO regulator 100 may be a pole-splitting-based LDO regulator.

The output voltage V_{OUT} of LDO regulator 100 may change when, for example, the input voltage V_{IN} changes, and/or the load current at the output of LDO regulator 100 changes. When the output voltage V_{OUT} decreases to a level lower than a target output voltage, the output voltage of first amplifier stage may decrease, the on-resistance and the voltage drop of the NFET transistor of second amplifier stage 120 may increase, and thus the voltage level at the gate of pass transistor 150 may increase to pull up the output voltage V_{OUT}. When the output voltage V_{OUT} is higher than the target output voltage, the output voltage of first amplifier stage may increase, the gate voltage and thus the drain current of the NFET transistor of second amplifier stage 120 may increase, such that the parasitic gate capacitor of pass transistor 150 may be discharged more quickly through the NFET transistor of second amplifier stage 120. As a result, the voltage level at the gate of pass transistor 150 may decrease, thereby decreasing the drain current of pass transistor 150 and the output voltage V_{OUT} of LDO regulator 100. It is desirable that an LDO regulator can respond to changes in the output voltage as quick as possible, in order to reduce variations in the output voltage.

To increase the unity gain frequency and the load transient response performance while maintaining good phase margin and stability of LDO regulator 100, resistor 122 and capacitor 124 of the Miller compensation circuit may be connected in series between the output of first amplifier stage 110 and the gate of pass transistor 150 (which is connected to the output of second amplifier stage 120). First amplifier stage 110 may have a high output impedance, and thus a pole at the output of first amplifier stage 110 may be a dominant pole at a low frequency due to the high impedance and capacitor 124 of the Miller compensation. The second amplifier stage 120 may be biased at a high bias current and thus may have a high transconductance. The gate capacitance of NFET pass transistor 150 may be small. Therefore, a pole at the output of second amplifier stage 120 and the gate of pass transistor 150 may be a non-dominant pole at a higher frequency. The separation of the dominant pole and the non-dominant pole may increase the unity gain frequency and the phase margin at the unity gain frequency. In addition, resistor 122 of the Miller compensation circuit may be used to move a right-half plane (RHP) zero to the left-half plane, and set the frequency of the left-half plane (LHP) zero, which may help to negate the effect the poles, thereby increasing the unity gain frequency and improving the stability of LDO regulator 100.

As describe above, to increase the frequency of the non-dominant pole at the gate of pass transistor 150 for fast transient response and high PSRR, second amplifier stage 120 may be biased at a high bias current to have a high transconductance. In the NFET pass transistor-based LDO regulator 100, the bias current may be provided from charge pump 140, which may not have a high conversion efficiency, may increase the quiescent current for biasing second amplifier stage 120, and thus may reduce the current efficiency of LDO regulator 100. For example, if charge pump 140 has an efficiency about 50% and a voltage conversion ratio about 4, an input current about 8 μA may be used to provide an output current of 1 μA for biasing second amplifier stage 120. Thus, in the NFET pass transistor-based LDO regulator 100 that uses charge pump 140, the quiescent current may increase significantly. In addition, the size of charge pump 140 and/or the size of biasing circuit 130 (and thus the overall size of LDO regulator 100) may need to be increased to provide the bias current for achieving the desired transient performance of the LDO regulator. As such, it may be desirable to reduce the bias current from charge pump 140 for charging the gate capacitor and biasing second amplifier stage 120, while achieving good load transient response performance.

In some examples, an LDO regulator may include an additional feedback loop to control a dynamic biasing circuit to improve the load transient response of the LDO regulator, where the dynamic biasing circuit may consume no (or little) current and thus may supply zero (or little) current to the main feedback loop during steady state, and the additional feedback loop may have a low quiescent current. Thus, the additional feedback loop may not significantly increase the quiescent current during steady state operations of the LDO regulator. The dynamic biasing circuit may be turned on when the output voltage is lower than the target output voltage, to supply current to the gate of the pass transistor to pull up the gate voltage and thus the output voltage (e.g., at the source) of the pass transistor. When the output voltage is higher than the target output voltage, the output voltage of the first amplifier stage and the control voltage of the second amplifier stage may increase, such that the current flowing from the gate of the pass transistor through the second amplifier stage to ground may be increased to discharge the gate capacitor, thereby reducing the output voltage at the pass transistor. The dynamic biasing circuit may include a high-pass filter (HPF) that may pass high frequency variations of the output voltage to the amplifier directly (e.g., without being scaled down) to turn on the dynamic biasing circuit. Therefore, the LDO regulator can have a good load transient performance. The additional feedback loop can have a low gain and a high bandwidth to improve load transient response, and may have minimum or no impact on the stability of the main feedback loop of the LDO regulator.

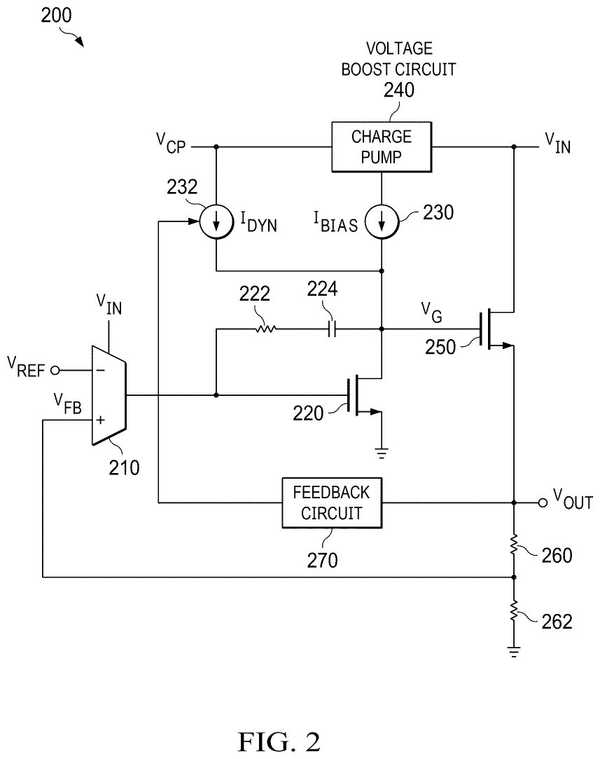

FIG. 2 is a schematic of an example of an NFET-based LDO regulator 200 including a dynamic biasing circuit that is adjustable based on the output level of LDO regulator 200. LDO regulator 200 may be similar to LDO regulator 100, and may include an auxiliary feedback loop to improve load transient response. In the illustrated example, LDO regulator 200 may include a pass transistor 250, and an amplifier that may include a first amplifier stage 210 and a second amplifier stage 220. LDO regulator 200 may also include a Miller compensation circuit that may include a resistor 222 and a capacitor 224, and an output feedback scaling circuit that may include a resistor 260 and a resistor 262. The output feedback scaling circuit, the amplifier, and the Miller compensation circuit may form a main feedback loop for controlling pass transistor 150.

LDO regulator 200 may further include a charge pump 240 (or another voltage boost circuit such as a bootstrap circuit) and a biasing circuit 230 (e.g., a current source) for driving pass transistor 250 and second amplifier stage 220. In addition, LDO regulator 200 may include a feedback circuit 270 that may sense the output voltage V_{OUT} and control a dynamic biasing circuit 232 to provide a dynamic bias current for charging the gate of pass transistor 250 during load transient to improve the load transient response of LDO regulator 200. Dynamic biasing circuit 232 may be disabled during steady-state operations of LDO regulator 200, and thus may not significantly increase the power consumption of LDO regulator 200.

Pass transistor 250 may have a drain coupled to an input voltage V_{IN}, a source coupled to a voltage output port of LDO regulator 200, and a gate coupled to the output of second amplifier stage 220. Pass transistor 250 may be an NFET transistor (or NPN) that can provide the desired current drive capability with a relatively small area on the die, and thus may have a small parasitic gate capacitor that can be charged at a high rate and/or using a smaller current. To provide an output voltage V_{OUT} that is close to input voltage V_{IN}, the voltage level at the gate of pass transistor 250 may need to be higher than the input voltage V_{IN} because a voltage difference between the gate and source (the output port of LDO regulator 200) needs to be greater than the threshold voltage V_{T} of pass transistor 250 to turn on pass transistor 250. The higher voltage level at the gate may be supplied by charge pump 240 or another voltage boost circuit (e.g., a bootstrap circuit). Charge pump 240 may receive input from input voltage V_{IN}, and may store the energy (e.g., using capacitors) to provide an output voltage V_{CP} that is higher than input voltage V_{IN}. As shown in FIG. 2, the output voltage V_{CP} of charge pump 240 may be used to drive a biasing circuit 230 (e.g., a current source) to set the voltage level at the gate of pass transistor 250. The output of charge pump 240 may also be used to bias the second amplifier stage 220, the output of which is coupled to the gate of pass transistor 250. As described above, charge pump 240 may have power loss and may need an input current that is a few times higher than the output current of charge pump 240 due to the voltage up-conversion and power loss.

The amplifier may drive pass transistor 250 based on a difference between a feedback voltage V_{FB} and a reference voltage V_{REF} to regulate the output voltage V_{OUT}. The reference voltage V_{FB} may be generated by, for example, a bandgap voltage reference or another reference voltage generation circuit. The feedback voltage may be a fraction of the output voltage V_{OUT}. The values of resistors 260 and 262 may be selected based on the voltage levels of the reference voltage and the target output voltage, to set the desired voltage dividing ratio of the voltage divider formed by resistors 260 and 262.

First amplifier stage 210 of the amplifier in the main feedback loop may include a differential amplifier that receives, for example, input voltage V_{IN}, as a supply voltage, and may amplify the difference between the feedback voltage V_{FB} and the reference voltage V_{REF} (or a scaled-down version of the reference voltage V_{REF}). The output of first amplifier stage 210 may be coupled to the input of second amplifier stage 220, which may perform the voltage level shifting between the output of first amplifier stage 210 and the gate of pass transistor 250. In the illustrated example, second amplifier stage 220 may include a common-source amplifier formed by an NFET transistor. The gate of the NFET transistor may be coupled to the output of first amplifier stage 210, the source of the NFET transistor may be coupled to ground, whereas the drain of the NFET transistor may be coupled to biasing circuit 230 and the gate of pass transistor 250. Second amplifier stage 220 may function as a buffer to isolate the output of first amplifier stage 210 and the gate of pass transistor 250, such that a pole at the gate of pass transistor 250 and a pole at the output of first amplifier stage 210 may be separate. Therefore, LDO regulator 200 may be a pole-splitting-based LDO regulator.

The output voltage V_{OUT} may change when, for example, the input voltage V_{IN} changes, and/or the load current at the output of LDO regulator 200 changes. When the output voltage V_{OUT} is lower than the target output voltage, the output voltage of first amplifier stage 210 may decrease, such that the gate voltage and the drain current of the NFET transistor of second amplifier stage 220 may decrease, and the voltage drop across the NFET transistor of second amplifier stage 220 may increase. Therefore, the voltage level at the gate of pass transistor 250 may increase to increase the drain current of pass transistor 250, thereby pulling up the output voltage V_{OUT}. When the output voltage V_{OUT} is higher than the target output voltage, the output voltage of first amplifier stage may increase, and thus the gate voltage and the drain current of the NFET transistor of second amplifier stage 220 may increase, such that the gate capacitor of pass transistor 250 may be discharged through the NFET transistor of second amplifier stage 220. As a result, the voltage level at the gate of pass transistor 250 may decrease, thereby decreasing the drain current of pass transistor 250 and the output voltage V_{OUT}. It is desirable that LDO regulator 200 can respond to changes in the output voltage as soon as possible, to reduce variations in the output voltage V_{OUT}.

To increase the unity gain frequency and load transient response performance while maintaining good phase margin and stability of LDO regulator 200, resistor 222 and capacitor 224 of the Miller compensation circuit may be connected in series between the output of first amplifier stage 210 and the gate of pass transistor 250 (and the output of second amplifier stage 220). First amplifier stage 210 may have a high output impedance, and thus a pole at the output of first amplifier stage 210 may be a dominant pole at a low frequency due to the high impedance and capacitor 224 of the Miller compensation circuit. The second amplifier stage 220 may be biased at a high bias current and thus may have a high transconductance, and the gate capacitance of NFET pass transistor 250 may be small. Therefore, a pole at the output of second amplifier stage 220 and the gate of pass transistor 250 may be a non-dominant pole at a higher frequency. The separation of the dominant pole and the non-dominant pole may increase the unity gain frequency and the phase margin at the unity gain frequency. In addition, resistor 222 of the Miller compensation circuit may be used to move the RHP zero to the LHP, and set the frequency of the LHP zero, which may help to negate the effect the poles, thereby increasing the unity gain frequency and improving the stability of LDO regulator 200.

To further improve the fast transient response and PSRR and to reduce the quiescent current while LDO regulator 200 operates in a steady state, the biasing circuit for biasing the second amplifier stage 220 and the gate of pass transistor 250 may include biasing circuit 230 and dynamic biasing circuit 232, where biasing circuit 230 may be active during both steady-state and transient operations of LDO regulator 200, while dynamic biasing circuit 232 may be turned on when the output voltage of LDO regulator 200 is below the target output voltage and may be turned off under other operating conditions. Feedback circuit 270 may sense the high-frequency variations in the output voltage V_{OUT} and control dynamic biasing circuit 232 accordingly, such that dynamic biasing circuit 232 can be turned on to provide additional current to charge the gate capacitor and thus increase the voltage level at the gate of pass transistor 250 when the output voltage of LDO regulator 200 is below the target output voltage. Increase the voltage level at the gate of pass transistor 250 may increase the drive capability (e.g., drain current) of pass transistor 250 and pull up the voltage level of output voltage V_{OUT}. As described above, when the output voltage of LDO regulator 200 is higher than the target output voltage, the voltage level at the gate of the NFET transistor of the common-source amplifier of second amplifier stage 220 may increase, and the gate capacitor of pass transistor 250 may be discharged through the NFET transistor to reduce the voltage level at the gate of pass transistor 250, thereby reducing the drain current of pass transistor 250 and the output voltage of LDO regulator 200.

In this way, the bias current during the steady-state operation can be reduced to reduce the quiescent current of LDO regulator 200. During load transient or when the output voltage is otherwise below the target output voltage, the dynamic biasing circuit can be turned on so that the total bias current can be higher to pull up the gate voltage of pass transistor 250 quickly, thereby improving the transient response. As such, LDO regulator 200 can have a lower quiescent current, without sacrificing the load transient response performance. In some examples, a high-pass filter may be used to pass the high-frequency variations to the feedback circuit 270 directly (e.g., without being scaled down) to further improve the transient response and PSRR as described in more detail below.

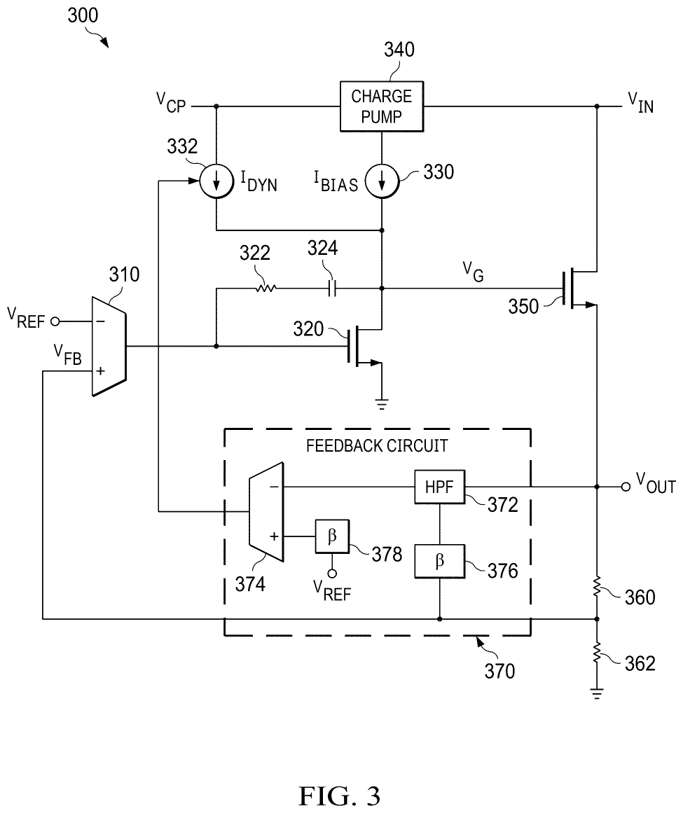

FIG. 3 is a schematic of an example of an LDO regulator 300. LDO regulator 300 may be an example of LDO regulator 200 of FIG. 2. As LDO regulator 200, LDO regulator 300 may include an N-type pass transistor 350 (e.g., NFET or NPN) and an amplifier that may include a first amplifier stage 310 and a second amplifier stage 320. LDO regulator 300 may also include an output feedback scaling circuit that may include a resistor 360 and a resistor 362. The amplifier and the output feedback scaling circuit may form a main feedback loop with pass transistor 350 to regulate the output voltage V_{OUT} of LDO regulator 300. LDO regulator 300 may also include a compensation circuit that may include a resistor 322 and a capacitor 324. The compensation circuit may be a Miller compensation circuit to improve the stability of the amplifier and the main feedback loop. LDO regulator 300 may further include a charge pump 340 and a biasing circuit 330 (e.g., a current source) for providing a bias current I_{BIAS} (which may be a constant or a relatively stable current) to bias or drive pass transistor 350 and second amplifier stage 320. Compared with biasing circuit 130 of LDO regulator 100, biasing circuit 330 can be designed to provide a smaller bias current and can have a smaller size. These components may otherwise function in manners similar to the corresponding components of LDO regulator 200 described above, and thus are not described in detail again.

LDO regulator 300 may include a feedback circuit 370 and a dynamic biasing circuit 332 for improving the transient response while reducing the quiescent current during steady-state operations of LDO regulator 300. Feedback circuit 370 and dynamic biasing circuit 332 may form an auxiliary feedback loop with pass transistor 350. Feedback circuit 370 may be an example of an implementation of feedback circuit 270 described above, and may sense the output voltage V_{OUT} and control dynamic biasing circuit 332 to provide a dynamic bias current for charging the gate of pass transistor 350 during load transient to improve the load transient response of LDO regulator 300.

In the illustrated example, feedback circuit 370 may include an amplifier 374, which may be a high-bandwidth differential amplifier. Amplifier 374 can include a standard operational transconductance amplifier (OTA) and can be insensitive to variations in the process and operational conditions. Amplifier 374 may have a low quiescent current (e.g., about 1 μA) and a small area. The inputs to amplifier 374 may include a fraction of the reference voltage V_{REF} provided through a voltage divider 378, and a sum of a fraction of the output voltage V_{OUT} (or a feedback voltage that is a fraction of the output voltage) provided through a voltage divider 376 and high-frequency components of the output voltage V_{OUT} provided through a high-pass filter (HPF) 372. Voltage dividers 376 and 378 may be implemented using, for example, a resistor voltage divider having a dividing ratio β. An example of an implementation of the high-pass filter is a capacitor. The output of amplifier 374 may control dynamic biasing circuit 332 to provide a dynamic bias current I_{DYN} to charge the node at the gate of pass transistor 350 and the output (e.g., the drain of an NFET transistor) of second amplifier stage 320. Dynamic biasing circuit 332 may be a variable current source that may provide different amounts of current under different voltage control signals.

When the load of LDO regulator 300 increases quickly (e.g., from below or around 1 mA or 1 μA to a few hundred mA in about 1 μs), the output voltage V_{OUT} may drop momentarily because LDO regulator 300 may need time to respond to the load change. High-pass filter 372 may pass the falling edge of output voltage V_{OUT} to amplifier 374 instantly, which may then provide a higher output voltage signal to turn on dynamic biasing circuit 332 to provide or increase the dynamic bias current I_{DYN}, such that the voltage level V_{G} at the gate of pass transistor 350 may increase rapidly. The increased voltage level V_{G} at the gate of pass transistor 350 may increase the voltage difference V_{GS} between the gate and the source of pass transistor 350, thereby increasing the drain current I_{D} (or drain-to-source current I_{DS}) of pass transistor 350 to supply a higher load current and pull up output voltage V_{OUT}. Due to the high bandwidth of amplifier 374, the auxiliary feedback loop can respond to output voltage drop rapidly to pull the output voltage up instantaneously.

During steady state operations of LDO regulator 300 or a rising of output voltage V_{OUT}, the output of amplifier 374 may be low and thus dynamic biasing circuit 332 may not be turned off and thus may provide no dynamic bias current, such that second amplifier stage 320 may only receive bias current I_{BIAS} from biasing circuit 330. For example, when the load of LDO regulator 300 decreases quickly, the output voltage V_{OUT} may increase momentarily. The higher output voltage V_{OUT} may cause the output voltage of first amplifier stage 310 to increase, which in turn may increase the drain current of the NFET transistor of second amplifier stage 320 to more quickly discharge the gate capacitor of pass transistor 350, such that the voltage level V_{G} at the gate of pass transistor 350 may be reduced to reduce the drain current of pass transistor 350. Thus, feedback circuit 370 and dynamic biasing circuit 332 can be disabled or otherwise inactive when, for example, current is sunk from the gate capacitor of pass transistor 350.

The auxiliary feedback loop formed by feedback circuit 370 and dynamic biasing circuit 332 may have minimum or no impact on the stability of the main feedback loop for regulating the output voltage of LDO regulator 300, and can further stabilize the output voltage level during fast transient and suppress supply noise to achieve higher power supply rejection ratio. As described above, dynamic biasing circuit 332 may be turned off during steady state operations of LDO regulator 300, and biasing circuit 330 can be designed to provide a smaller bias current (e.g., compared with biasing circuit 130 of LDO regulator 100) during the steady state operations of LDO regulator 300. Therefore, during the steady state operations, the quiescent current of LDO regulator 300 can be reduced, without impacting the transient response performance of LDO regulator 300.

As described above, a large bias current can be used to bias the second amplifier stage to push the non-dominant pole at the gate of the pass transistor to a higher frequency, thereby improving the fast transient response and PSRR. For example, when the bias current for the second amplifier stage is low, the transconductance of the second amplifier stage may be low, and thus the non-dominant pole at the gate of the pass transistor may move to a lower frequency, which may reduce the stability and the operating frequency range of the LDO regulator. Dynamic or adaptive biasing described above may be used to reduce the bias current from the charge pump and thus the total quiescent current during stead-state operations, and to provide a small dynamic bias current at relatively low load (and thus relatively small voltage drop at the output voltage V_{OUT}). However, if all bias current for the second amplifier stage and the gate of the pass transistor is provided by the charge pump, the charge pump may need to support a relatively high dynamic bias current for heavy load, in order to quickly charge the gate capacitor of the pass transistor and pull up the output voltage of the LDO regulator. Therefore, the charge pump may need to have a large area in order to support the high total bias current for heavy load. As described above, the charge pump may have a low efficiency and may significantly increase the quiescent current of the LDO regulator. As such, it may be desirable to reduce the bias current supplied from the charge pump.

In some examples, to further reduce the quiescent current of an LDO regulator, the LDO regulator may use split biasing to provide a large bias current directly from the input voltage to the second amplifier stage and provide a small bias current through the charge pump to the gate of the pass transistor (and a level shifter of the second amplifier stage). The large bias current to the second amplifier stage from the input voltage can increase the transconductance of the second amplifier stage and thus the frequency of the non-dominant pole at the gate of the pass transistor to increase the bandwidth and improve transient and PSRR performance at both low load and high load. The level shifter (if used) may be driven by a small bias current from the charge pump and may shift the output voltage of the second amplifier stage to a higher level to drive the gate of the pass transistor, such that the output voltage of the LDO regulator may be closer to the input voltage. The level shifter may also help to isolate the gate of the pass transistor from the input voltage to reduce noise in the output voltage that may otherwise be caused by noise in the input voltage. In this way, the quiescent current provide through the charge pump may be reduced because the charge pump may only need to provide a small bias current for level shifting and gate capacitor charging purposes, and thus the total quiescent current of the LDO regulator can be reduced, without negatively impacting the stability and transient response performance of the LDO regulator. In addition, the area of the charge pump on the semiconductor die can be reduced as it may only need to provide a relatively small bias current, even when the load at the output of the LDO regulator is high.

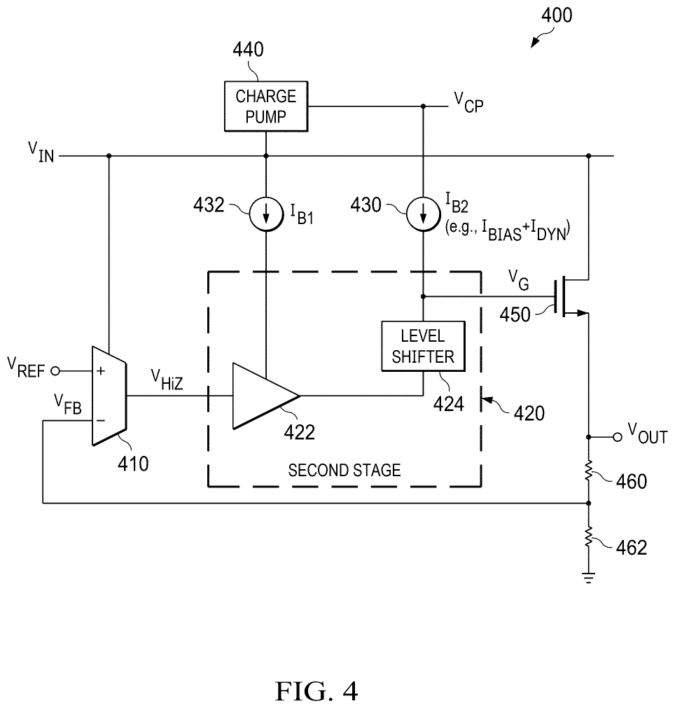

FIG. 4 is a schematic of an example of an NFET-based LDO regulator 400 including split biasing circuits. LDO regulator 400 can be an example of or can be a part of LDO regulators 200 and 300. As LDO regulators 200 and 300, LDO regulator 400 may include an N-type pass transistor 450 and an amplifier that may include a first amplifier stage 410 and a second amplifier stage 420. LDO regulator 400 may also include an output feedback scaling circuit that may include a resistor 460 and a resistor 462. The amplifier, the output feedback scaling circuit, and pass transistor 450 may form a main feedback loop for regulating the output voltage V_{OUT} of LDO regulator 400. LDO regulator 400 may also include a charge pump 440 that may convert the input voltage V_{IN} to a higher output voltage V_{CP}.

Pass transistor 450 may have a current terminal (e.g., drain) coupled to an input voltage V_{IN}, a source coupled to a voltage output port of LDO regulator 400, and a gate coupled to the output of second amplifier stage 420. Thus, pass transistor 450 may be controlled by the output of the amplifier. Pass transistor 450 may be an NFET transistor that can provide the desired current drive capability with a relatively small area on the semiconductor die, and thus can have a relatively small parasitic gate capacitor that can be charged at a high rate and/or with a smaller current. The small gate capacitance can help to push the non-dominant pole at the gate of pass transistor 450 to a higher frequency, thereby improving the stability and providing fast transient response of LDO regulator 400.

To provide an output voltage V_{OUT} close to input voltage V_{IN}, the voltage level at the gate may need to be higher than the input voltage because a voltage difference between the gate and source (the output of LDO regulator 400) needs to be greater than the threshold voltage V_{T} of pass transistor 450 in order to turn on pass transistor 450. The higher voltage level at the gate can be supplied by charge pump 440. Charge pump 440 may be similar to charge pump 140, 240, or 340, and may receive input from input voltage V_{IN} and provide the higher output voltage V_{CP}. As described above, charge pump 440 may have power loss and may need an input current that is a few times higher than the output current of charge pump 440 due to the voltage up-conversion and power loss.

First amplifier stage 410 may include a differential amplifier that receives, for example, input voltage V_{IN}, as a supply voltage, and may amplify the difference between feedback voltage V_{FB} and reference voltage V_{REF}. First amplifier stage 410 may have a large output impedance and thus a pole at the output of first amplifier stage 410 may be a dominant pole at a low frequency. The output of first amplifier stage 410 may be coupled to the input of the second amplifier stage 420, which may perform the voltage level shifting between the output of first amplifier stage 410 and the gate of pass transistor 450. In the illustrated example, second amplifier stage 420 may include a buffer 422 and a level shifter 424. Buffer 422 may be powered by the input voltage and may isolate the gate of pass transistor 450 from the first amplifier stage to enable pole splitting. Level shifter 424 may be powered by charge pump 440 and may be used to shift the output voltage of buffer 422 to a higher level to control the gate of pass transistor 450.

LDO regulator 400 may also include a first biasing circuit 432 (e.g., a current source) for providing a bias current I_{B1} to the second amplifier stage from input voltage V_{IN} directly, and a second biasing circuit 430 (e.g., a current source) for providing a small bias current I_{B2} from charge pump 440 to bias or drive level shifter 424 and the gate of pass transistor 450. First biasing circuit 432 may provide a large bias current I_{B1} to increase the transconductance of buffer 422 for a high loop bandwidth, while charge pump 440 and second biasing circuit 430 may only need to provide a small bias current for level shifting and gate capacitor charging purposes. Therefore, both charge pump 440 and second biasing circuit 430 can use smaller area on the semiconductor die, the total quiescent current of LDO regulator 400 can be reduced, without sacrificing the stability and load transient response performance of LDO regulator 400.

As described above, a feedback signal V_{FB} that is a scaled-down version of the output voltage V_{OUT} may be provided to first amplifier stage 410 by a voltage divider formed by resistors 460 and 462. The feedback signal V_{FB} may be compared with reference voltage V_{REF}, to determine whether the output voltage V_{OUT} is at, above, or below a target output voltage. When the output voltage V_{OUT} is lower than the target output voltage, the output voltage of the first amplifier stage may increase, and thus the output voltage of buffer 422 and a level-shifted version of output voltage of buffer 422 at the gate of pass transistor 450 may increase. Charge pump 440 and second biasing circuit 430 may provide the current for level shifting and charging the gate capacitor of pass transistor 450 to the higher voltage level. The increase of the gate voltage may increase the drain current of pass transistor 450, such that the output voltage V_{OUT} may be pulled up. When the output voltage V_{OUT} is higher than the target output voltage, the output voltage of the first amplifier stage may decrease, and thus the output voltage of buffer 422 and a level-shifted version of output voltage of buffer 422 at the gate of pass transistor 450 may decrease as well. The decrease of the gate voltage may decrease the drain current of pass transistor 450, such that the output voltage V_{OUT} may be decreased. In this way, the out voltage V_{OUT} may be relatively stable.

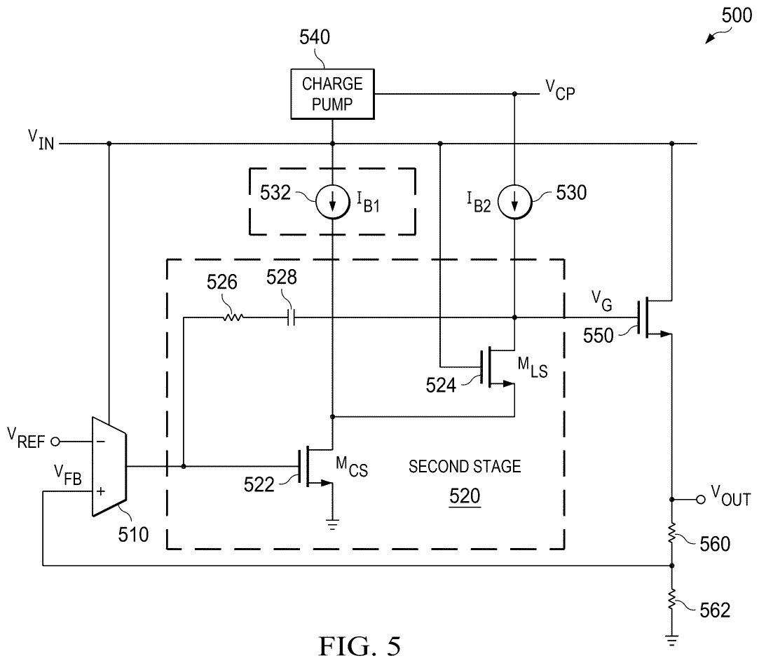

FIG. 5 is a schematic of an example of an LDO regulator 500, which may be an example of LDO regulator 400 of FIG. 4. As LDO regulator 400, LDO regulator 500 may include an N-type pass transistor 550 and an amplifier that may include a first amplifier stage 510 and a second amplifier stage 520 that may be examples of first amplifier stage 410 and second amplifier stage 420, respectively. LDO regulator 500 may also include an output feedback scaling circuit that may include a voltage divider formed by a resistor 560 and a resistor 562. The amplifier, the output feedback scaling circuit, and pass transistor 550 may form a main feedback loop for regulating the output voltage V_{OUT} of LDO regulator 500. LDO regulator 500 may also include a charge pump 540 that may convert the input voltage V_{IN} into a higher output voltage V_{CP}. Charge pump 540 may be an example of charge pump 440. The first amplifier stage 510 may be powered by input voltage V_{IN} directly.

Second amplifier stage 520 shown in FIG. 5 is an example of an implementation of second amplifier stage 420. In the illustrated example, second amplifier stage 520 may include an NFET transistor 522 in a common-source configuration to implement buffer 422. Second amplifier stage 520 may also include an NFET transistor 524 that may be configured to implement level shifter 424. The gate of NFET transistor 522 may be connected to the output of first amplifier stage 510, the source of NFET transistor 522 may be connected to ground, and the drain of NFET transistor 522 may be connected to first biasing circuit 532 and the source of NFET transistor 524. The gate of NFET transistor 524 may be connected to the input voltage V_{IN} or the output of charge pump 540, and the drain of NFET transistor 524 may be connected to second biasing circuit 530 and the gate of pass transistor 550. Thus, first amplifier stage 510 and transistor 522 of second amplifier stage 520 are both powered by the input voltage, while transistor 524 and the gate of pass transistor 550 may be biased or driven by the output of charge pump 540. Therefore, transistor 524 isolates the gate of pass transistor from the domain of the input voltage V_{IN}, and can also create a feedforward path for supply noise cancellation. For example, when there is noise on the input voltage, the gate of NFET transistor 524 may receive the noisy input voltage, the source of NFET transistor 524 may also receive a noisy signal through first amplifier stage 510 and NFET transistor 522, and thus the voltage difference between the gate and source of transistor 524 may not be affected by the noise in the input voltage. As such, the gate voltage of pass transistor 550 may not be affected by the noise in the input voltage.

Second amplifier stage 520 may also include a compensation circuit that includes a resistor 526 and a capacitor 528. As described above (e.g., with respect to FIG. 2), capacitor 528 may be used to form a pole at the output of first amplifier stage 510, which may be a dominant pole at a low frequency due to the high output impedance of first amplifier stage 510 and capacitor 528 of the Miller compensation. Resistor 526 of the Miller compensation circuit may be used to set the frequency of an LHP zero, which may help to negate the effect of the poles, thereby increasing the unity gain frequency and improving the stability of LDO regulator 500.

As shown in FIG. 5, transistor 522 in second amplifier stage 520 may be powered by input voltage V_{IN} through a first biasing circuit 532, which may provide a large current to transistor 522 to increase the transconductance of transistor 522, thereby setting a non-dominant pole at a high frequency. As such, the main feedback loop of LDO regulator 500 may have a higher bandwidth for better transient response and higher PSRR. Transistor 522 in second amplifier stage 520 may be partially biased by a current from second biasing circuit 530 through transistor 524, where the current from second biasing circuit 530 may be small. Transistor 524 may be powered by the small current from charge pump 540 through second biasing circuit 530 for level-shifting. Thus, this split biasing technique may allow charge pump 540 to provide only a small biasing current I_{B2} to transistor 524 to shift the output voltage of transistor 522 to a higher level at the gate of pass transistor 550. Due to the small biasing current I_{B2}, the area of charge pump 540 and second biasing circuit 530 can be small on the semiconductor die. The total quiescent current of LDO regulator 500 may also be reduced due to the small bias current from charge pump 540.

During operations of LDO regulator 500, a feedback signal V_{FB} that is a scaled-down version of the output voltage V_{OUT} may be provided to first amplifier stage 510 by a voltage divider formed by resistors 560 and 562. The feedback signal V_{FB} may be compared with reference voltage V_{REF}, to determine whether the output voltage V_{OUT} is at, above, or below a target output voltage. When the output voltage V_{OUT} is lower than the target output voltage, the output voltage of the first amplifier stage may decrease, which may reduce the gate voltage of transistor 522, such that the drain current of transistor 522 may reduce and the voltage level at the drain of transistor 522 may increase. Therefore, a level-shifted version of the drain voltage of transistor 522 at the drain of transistor 524 and the gate of pass transistor 550 may increase as well. Charge pump 540 and second biasing circuit 530 may provide the current to charge the gate capacitor of pass transistor 550 to the higher voltage level. The increase of the gate voltage of pass transistor 550 may increase the drain current of pass transistor 550, such that the output voltage V_{OUT} may be pulled up. When the output voltage V_{OUT} is higher than the target output voltage, the output voltage of the first amplifier stage may increase, which may increase the gate voltage of transistor 522, such that the drain current of transistor 522 may increase and the voltage level of the drain of transistor 522 may decrease. Therefore, a level-shifted version of the drain voltage of transistor 522 at the gate of pass transistor 550 may decrease as well. The decrease of the gate voltage may decrease the drain current of pass transistor 550, such that the output voltage V_{OUT} may be decreased. In this way, the out voltage V_{OUT} may be relatively stable.

In some examples, second biasing circuit 530 may include a static biasing circuit configured to provide a pre-determined bias current to transistor 524, and a dynamic biasing circuit configured to provide a variable dynamic bias current that may be output-dependent to charge the gate capacitor of pass transistor 550 during load transient as described above with respect to, for example, FIGS. 2 and 3. In some examples, first biasing circuit 532 may also include a static biasing circuit configured to provide a pre-determined bias current to transistor 522, and a dynamic biasing circuit configured to provide a variable dynamic bias current that may be output-dependent to provide a higher bias current to transistor 522 during load transient.

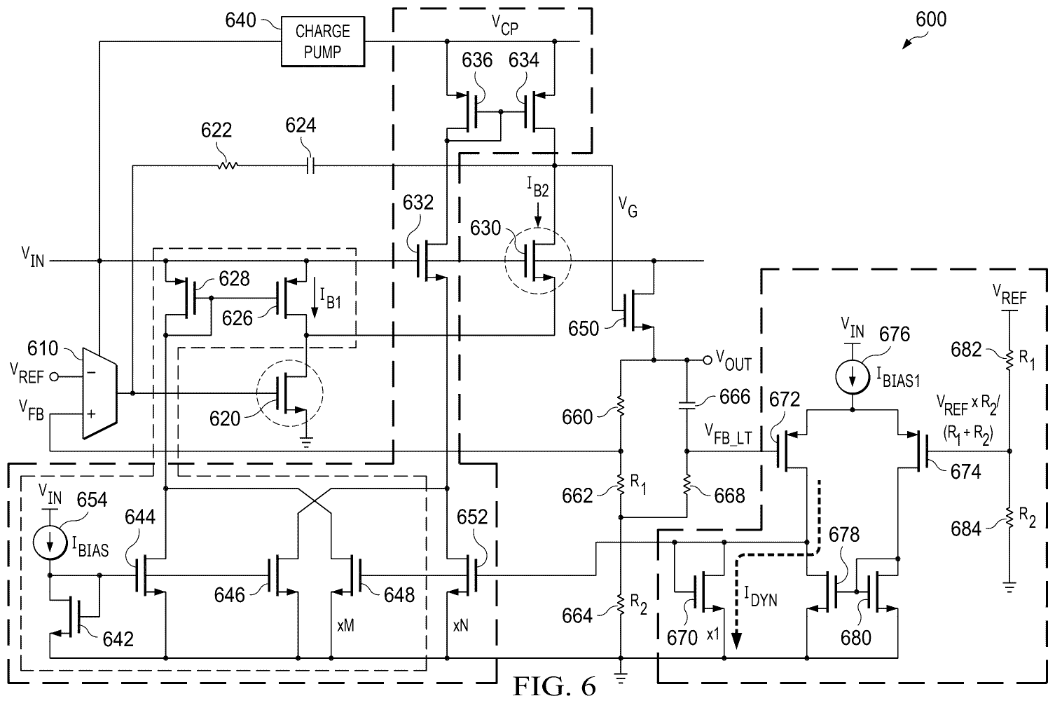

FIG. 6 is a schematic of an example of an LDO regulator 600 including split biasing circuits where at least one biasing circuit is adjustable based on the output level of LDO regulator 600. LDO regulator 600 may be an example of, or may include, LDO regulators 200, 300, 400, and 500. In the illustrated example, LDO regulator 600 may include an N-type pass transistor 650 and an amplifier that may include a first amplifier stage 610 and a second amplifier stage. The second amplifier stage may include a common-source amplifier formed by an NFET transistor 620, a Miller compensation circuit including a resistor 622 and a capacitor 624, and a level shifter formed by an NFET transistor 630 (which may or may not be considered part of the second amplifier stage). As described above, capacitor 624 may be used to form a pole at the output of first amplifier stage 610, which may be a dominant pole at a low frequency due to the high output impedance of first amplifier stage 610 and capacitor 624 of the Miller compensation. Resistor 622 of the Miller compensation circuit may be used to set the frequency of an LHP zero, which may help to negate the effect of the poles, thereby increasing the unity gain frequency and improving the stability of LDO regulator 600.

LDO regulator 600 may also include an output feedback scaling circuit that may include a voltage divider formed by a resistor 660, a resistor 662, and a resistor 664. The amplifier, the output feedback scaling circuit, and pass transistor 650 may form a main feedback loop for regulating the output voltage V_{OUT} of LDO regulator 600. LDO regulator 600 may further include a charge pump 640 that may convert the input voltage V_{IN} into a higher output voltage V_{CP}. Charge pump 640 may be an example of charge pump 440. First amplifier stage 610 may be powered by input voltage V_{IN} directly. Transistor 620 (which may be an example of second amplifier stage 420 or buffer of FIG. 4) may be powered by input voltage V_{IN} and by charge pump 640. Transistor 630 (or another level shifter) may be powered by charge pump 640. LDO regulator 600 may include other circuits for biasing the first amplifier stage and second amplifier stage, and circuits for sensing the output voltage variations and controlling the biasing circuit accordingly.

For example, LDO regulator 600 may include a feedback circuit (which may be an example of an implementation of feedback circuit 270 or 370) that may include a high-pass filter (e.g., capacitor 666), a first voltage divider (e.g., including resistors 662 and 664), a second voltage divider (e.g., including resistors 682 and 684), an auxiliary amplifier (e.g., including a current source 676, and transistors 672, 674, 678, and 680) that may have a low gain but a high bandwidth, and a voltage-to-current converter (e.g., including transistor 670). As illustrated, the output voltage V_{OUT} may be coupled to the gate of transistor 672 through capacitor 666, such than any high frequency variations in the output voltage may be coupled to one input of the high-bandwidth, low-gain auxiliary amplifier, without being divided by a voltage divider. Therefore, the feedback circuit may be more sensitive to high-frequency variations in the output voltage. The output voltage may also be divided by resistor 660 and a sum of resistors 662 and 664 to generate the feedback voltage V_{FB} for first amplifier stage 610. The values of resistors 660, 662, and 664 can be selected to divide the output voltage such that the auxiliary amplifier may be able to operate at low input voltage V_{IN}, such as around 1.4 V.

The feedback voltage V_{FB} may be divided by the first voltage divider formed by resistor 662 and 664 so that a fraction of the feedback voltage V_{FB} may be provided to the gate of transistor 672 through resistor 668. Thus, the input signal at the gate of transistor 672 may be the sum of the DC level (which may be a fraction of the DC level of the output voltage V_{OUT}) and the high frequency AC signal of the output voltage V_{OUT}. Similarly, reference voltage V_{REF} may be divided by the second voltage divider formed by resistors 682 and 684, such that a fraction of the reference voltage V_{REF} may be provided to the other input (e.g., the gate of transistor 674) of the auxiliary amplifier. The gates of transistors 678 and 680 are coupled together, and the source of transistors 678 and 680 are also coupled together, such that the drain currents of transistors 678 and 680 may be the same. In steady state, the voltage levels at the two inputs of the auxiliary amplifier may be the same, such that the drain currents of transistors 672 and 674 may be the same. When the voltage levels at the two inputs of the auxiliary amplifier are different, the drain currents of transistors 672 and 674 may be different. The difference in the drain currents passing through transistors 672 and 674 caused by the difference between the gate voltages of transistors 672 and 674 may follow through transistor 670. Therefore, the change in drain current of transistor 670 may indicate the change in the output voltage V_{OUT}, and can be used to control the bias currents of the first biasing circuit and the second biasing circuit as described in detail below.

The first biasing circuit (which may be an example of an implementation of first biasing circuit 532) may include a current source 654, and transistors, 626, 628, 642, 644, and 648. The first biasing circuit may be used to generate a bias current for driving transistor 620. The biasing circuit generated by the first biasing circuit may include a static bias current set by current source 654, transistors 642 and 644 (which form a first current mirror due to the same gate-source voltage V_{GS}), and transistors 626 and 628 (which form a second current mirror due to the same V_{GS}). For example, the current from current source 654 may be mirrored to transistors 626 and 620 through the first current mirror and the second current mirror. In addition, the biasing current generated by the first biasing circuit may include a dynamic bias current set by transistors 670 and 648 (which form a third current mirror) and transistors 626 and 628. For example, the current caused by the difference of the two input voltages of the auxiliary amplifier may be mirrored to transistors 626 and 620 through the third current mirror and the second current mirror. The third current mirror may have a current ratio M that may be any desired value, such as 2, 4, 6, and the like, which may be achieved by, for example, making the channel width of transistor 648 M times of the channel width of transistor 670. Thus, the bias current generated by the first biasing circuit and provided to transistor 620 of the second amplifier stage may include a constant/static bias current and a variable/dynamic bias current that may be controlled based on the output voltage of the LDO regulator to provide a fast transient response and improve the PSRR. Both the constant static bias current and the variable dynamic bias current are provided from the input voltage V_{IN}, rather than from charge pump 640, to improve the current efficiency.

The second biasing circuit (which may be an example of second biasing circuit 530) may include current source 654, and transistors 632, 634, 636, 642, 646, and 652. The second biasing circuit may be used to generate a bias current for driving transistor 630. The biasing current generated by the second biasing circuit may include a static bias current set by current source 654, transistors 642 and 646 (which form a fourth current mirror due to the same V_{GS}), transistor 632, and transistors 634 and 636 (which form a fifth current mirror). For example, the current from current source 654 may be mirrored to transistors 634 and 630 through the fourth current mirror and the fifth current mirror. In addition, the biasing current generated by the second biasing circuit may include a dynamic bias current set by transistors 670 and 652 (which form a sixth current mirror) and transistors 632, 634, and 636. For example, the drain current of transistor 670 caused by the difference of the two input voltages of the auxiliary amplifier may be mirrored to transistors 634 and 630 through the sixth current mirror and the fifth current mirror. The sixth current mirror may have a current ratio N that may be any desired value, such as 2, 4, 6, and the like, which may be achieved by, for example, making the channel width of transistor 652 N times of the channel width of transistor 670. Thus, the bias current generated by the second biasing circuit and provided to transistor 630 of the second amplifier stage may include a constant static bias current and a variable dynamic bias current that may be dynamically controlled based on the output voltage of the LDO regulator to provide a fast transient response and improve the PSRR. Both the constant static bias current and the variable dynamic bias current are provided from charge pump 640 and can be small.

As shown in FIG. 6, the first amplifier stage 610 and the buffer (e.g., transistor 620) of the second amplifier stage are both powered by the input voltage, while the level shifter (e.g., transistor 630) and the gate of pass transistor 650 may be powered by the output of charge pump 640. Therefore, the level shifter (e.g., transistor 630) isolates the gate of pass transistor 650 from the domain of the input voltage V_{IN}, and can create a feedforward path for supply noise cancellation. For example, when there is noise on the input voltage, the gate of NFET transistor 630 may receive the noisy input voltage, the source of NFET transistor 630 may also receive a noisy signal at the drain of transistor 626 (and drain of transistor 620), and thus the voltage difference between the gate and source of transistor 630 may not be affected by the noise in the input voltage V_{IN}. As such, the drain of transistor 630 and thus the gate of pass transistor 650 may not be affected by the noise in the input voltage V_{IN}.

As illustrated in FIG. 6 and described above, transistor 620 in second amplifier stage may mainly be powered by input voltage V_{IN} through the first biasing circuit, which may provide a large current to transistor 620 to increase the transconductance of transistor 620, thereby setting a non-dominant pole at a high frequency. The dynamic biasing control based on the output voltage can further reduce the quiescent current during steady-state operations and can also improve the transient response and PSRR of LDO regulator 600. The high-pass filter in the feedback circuit for controlling the dynamic biasing can make the feedback circuit more sensitive to fast transient or other high-frequency variations in the load and the output voltage across the full output voltage range (even if the variation is relatively small compared with the DC level of the output voltage). The current mirrors (e.g., the third and the six current mirrors) having current ratios greater than one can further cause larger dynamic bias current to pull up the gate voltage of the pass transistor quickly. As such, LDO regulator 600 may also have a higher bandwidth for a better transient response and an improved power supply rejection ratio (PSRR).

In addition, since charge pump 640 and the second biasing circuit may provide a relatively small current to transistor 630 (for level shifting) and the gate of pass transistor 650 (for charging the gate capacitor), the area of charge pump 640 and the second biasing circuit can be small on the semiconductor die. The total quiescent current of LDO regulator 600 may also be reduced due to the small current from the charge pump.

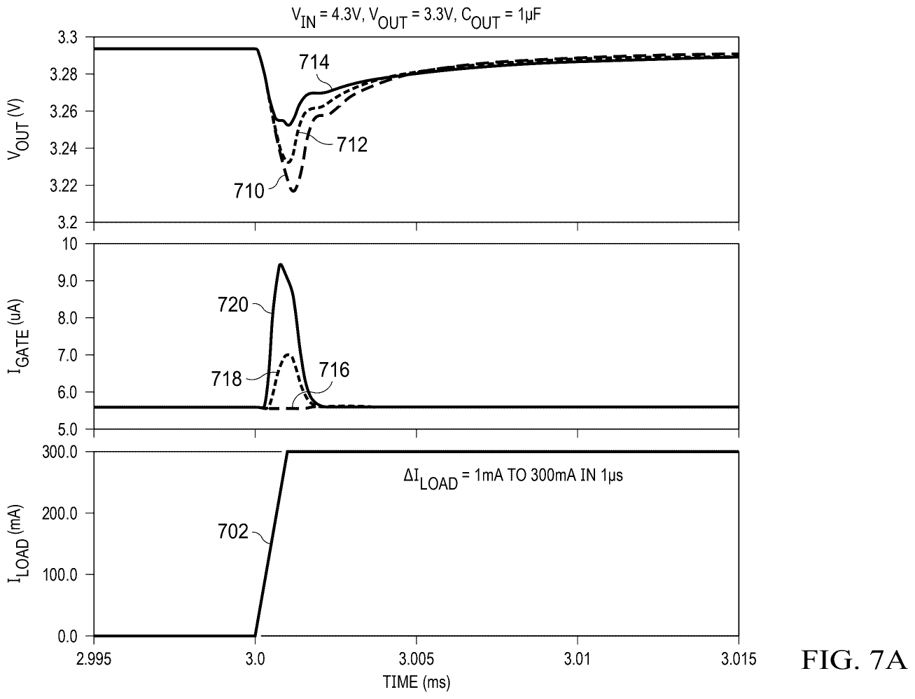

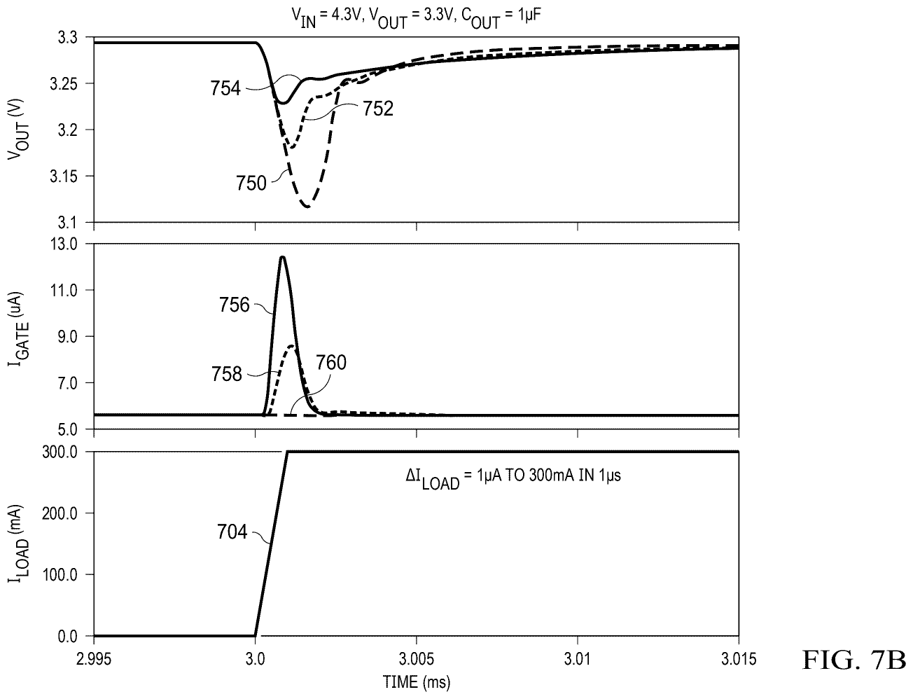

FIGS. 7A and 7B include graphs showing examples of simulation results for LDO regulators with and without dynamic biasing circuit as described herein. In the examples shown in FIG. 7A, the input voltage V_{IN} of the LDO regulators may be about 4.3 V, the target output voltage V_{OUT} may be about 3.3 V, the load capacitance may be about 1 μF, and the output load may be changed from about 1 mA to about 300 mA in about 1 μs as shown by a curve 702. The static bias current for charging the gate of the pass transistor may be less than about 6 μA.

In the first example shown in FIG. 7A, the LDO regulator may be an LDO regulator without the feedback circuit that includes the auxiliary amplifier and high-pass filter for dynamic bias control, such as LDO regulator 100 shown in FIG. 1. A curve 710 shows the voltage drop at the output of the LDO regulator when the load is changed from about 1 mA to about 300 mA in about 1 μs. A curve 716 shows the change of the bias current I_{G} for charging the gate of the pass transistor of the LDO regulator during the load transient. As shown by curves 710 and 716, during the fast load transient, there may be no increase in the bias current I_{G}, and the output voltage of the LDO regulator may drop by about ΔV_{OUT}=76.54 mV.

In the second example, the LDO regulator may be an LDO regulator with a feedback circuit that includes the auxiliary amplifier but not the high-pass filter (e.g., HPF 372 such as capacitor 666) for dynamic bias control. A curve 712 shows the voltage drop at the output of the LDO regulator when the load is changed from about 1 mA to about 300 mA in about 1 μs. A curve 718 shows the change of the bias current I_{G} for charging the gate of the pass transistor of the LDO regulator during the load transient. As shown by curves 712 and 718, during the fast load transient, there may be an increase in the bias current I_{G} about 1 μA, and the output voltage of the LDO regulator may drop by about ΔV_{OUT}=61.17 mV.

In the third example, the LDO regulator may be an LDO regulator with a feedback circuit that includes both the auxiliary amplifier and the high-pass filter (e.g., capacitor 666) for dynamic bias control, such as LDO regulator 200, 300, or 600. A curve 714 shows the voltage drop at the output of the LDO regulator when the load is changed from about 1 mA to about 300 mA in about 1 μs. A curve 720 shows the change of the bias current I_{G} for charging the gate of the pass transistor of the LDO regulator during the load transient. As shown by curves 714 and 720, during the fast load transient, an increase in the bias current I_{G} may be more than 3 μA, and the output voltage of the LDO regulator may drop by about ΔV_{OUT}=40.85 mV. Thus, an LDO regulator with the feedback circuit disclosed herein may significantly reduce the voltage drop (e.g., from about 76.54 mV to about 40.85 mV or about 45% reduction), and the HPF may also have a large impact on the voltage drop reduction (e.g., from about 61.17 mV to about 40.85 mV or about 33% reduction).

In the examples shown in FIG. 7B, the input voltage V_{IN} of the LDO regulators may be about 4.3 V, the target output voltage V_{OUT} may be about 3.3V, the load capacitance may be about 1 μF, and the output load may be changed from about 1 μA to about 300 mA in about 1 μs as shown by a curve 704. The static bias current for charging the gate of the pass transistor may be less than about 6 μA. Since the initial load is small, the pass transistor may be close to being turned off. Thus, the gate voltage of the pass transistor may be relatively low and may need to be increased by a large value in order to supply the load current that is about 300 mA.

In the first example shown in FIG. 7B, the LDO regulator may be an LDO regulator without the feedback circuit that includes the auxiliary amplifier and high-pass filter for dynamic bias control, such as LDO regulator 100 shown in FIG. 1. A curve 750 shows the voltage drop at the output of the LDO regulator when the load is changed from about 1 μA to about 300 mA in about 1 μs. A curve 760 shows the change of the bias current I_{G} for charging the gate of the pass transistor of the LDO regulator during the load transient. As shown by curves 750 and 760, during the fast load transient, there may be no increase in the bias current I_{G}, and the output voltage of the LDO regulator may drop by about ΔV_{OUT}=175.19 mV.

In the second example, the LDO regulator may be an LDO regulator with a feedback circuit that includes the auxiliary amplifier but not the high-pass filter (e.g., HPF 372 such as capacitor 666) for dynamic bias control. A curve 752 shows the voltage drop at the output of the LDO regulator when the load is changed from about 1 μA to about 300 mA in about 1 μs. A curve 758 shows the change of the bias current I_{G} for charging the gate of the pass transistor of the LDO regulator during the load transient. As shown by curves 752 and 758, during the fast load transient, there may be an increase in the bias current I_{G} about 3 μA, and the output voltage of the LDO regulator may drop by about ΔV_{OUT}=111.22 mV.

In the third example, the LDO regulator may be an LDO regulator with a feedback circuit that includes both the auxiliary amplifier and the high-pass filter (e.g., HPF 372 such as capacitor 666) for dynamic bias control, such as LDO regulator 200 or 300. A curve 754 shows the voltage drop at the output of the LDO regulator when the load is changed from about 1 μA to about 300 mA in about 1 μs. A curve 756 shows the change of the bias current I_{G} for charging the gate of the pass transistor of the LDO regulator during the load transient. As shown by curves 754 and 756, during the fast load transient, there may be an increase in the bias current I_{G} more than 7 HA, and the output voltage of the LDO regulator may drop by about ΔV_{OUT}=65.19 mV. Thus, an LDO regulator with the feedback circuit disclosed herein may significantly reduce the voltage drop (e.g., from about 175.19 mV to about 65.19 mV or about 63% reduction), and the HPF may also have a large impact on the voltage drop reduction (e.g., from about 111.22 mV to about 65.19 mV or about 40% reduction).

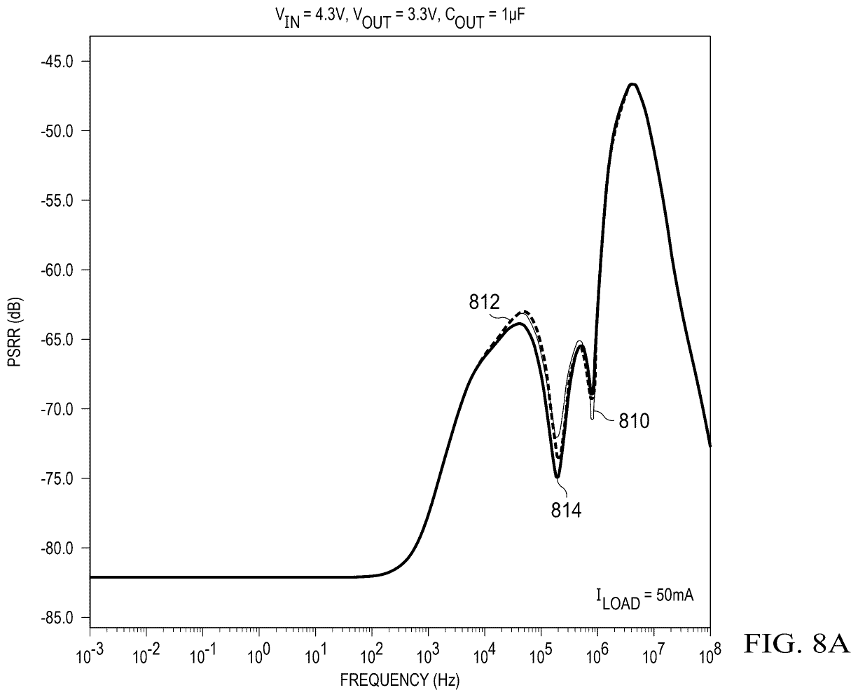

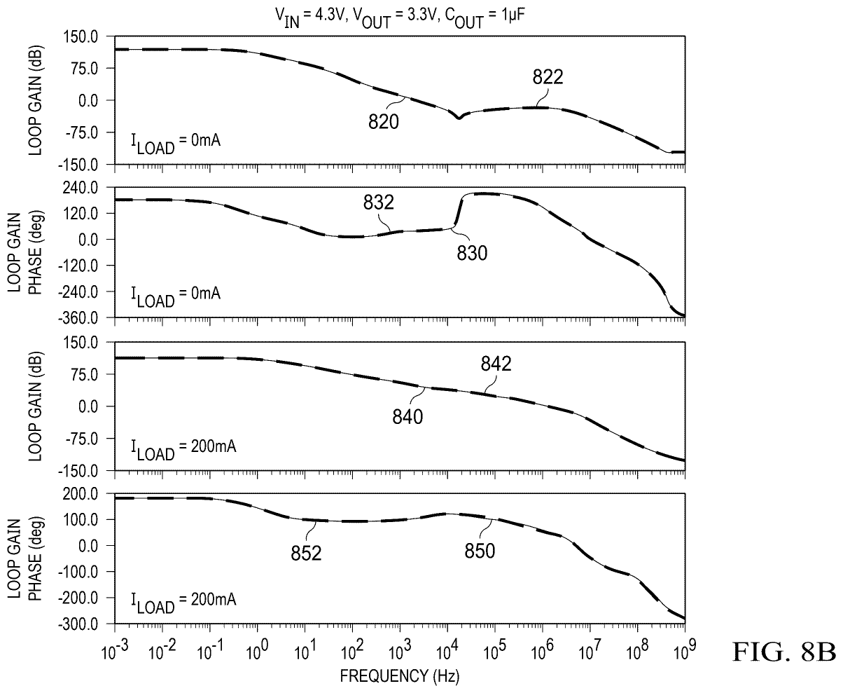

FIGS. 8A and 8B show examples of simulation results for LDO regulators with and without examples of dynamic biasing circuit as described herein. In the examples shown in FIG. 8A, the input voltage V_{IN} of the LDO regulators may be about 4.3 V, the target output voltage V_{OUT} may be about 3.3 V, the load capacitance may be about 1 μF, the output load may be about 50 mA, and the curves show the power supply rejection ratios of different LDO regulators when the input voltage has noises of different frequencies. In the first example shown by a curve 810, the LDO regulator may be an LDO regulator without the feedback circuit that includes the auxiliary amplifier and high-pass filter for dynamic bias control, such as LDO regulator 100 shown in FIG. 1. In the second example shown by a curve 812, the LDO regulator may be an LDO regulator with a feedback circuit that includes the auxiliary amplifier but not the high-pass filter (e.g., HPF 372 such as capacitor 666) for dynamic bias control. In the third example shown by a curve 814, the LDO regulator may be an LDO regulator with a feedback circuit that includes both the auxiliary amplifier and the high-pass filter (e.g., HPF 372 such as capacitor 666) for dynamic bias control, such as LDO regulator 200, 300, or 600. FIG. 8A shows that the PSRR of LDO regulators with the feedback circuit that includes the auxiliary amplifier and/or the high-pass filter may be improved at certain frequencies (e.g., between a few tens of kilohertz and a few hundreds of kilohertz)

FIG. 8B shows the magnitude (in dB) and phase (in degree) of the loop gain of the main feedback loop of LDO regulators with and without the dynamic biasing circuit that is adjustable based on the output level of the LDO regulator. In the examples shown in FIG. 8B, the input voltage V_{IN} of the LDO regulators may be about 4.3 V, the target output voltage V_{OUT} may be about 3.3 V, the load capacitance may be about 1 μF, the output load may be about 0 mA or 200 mA. A curve 820 and a curve 830 show the loop gain magnitude and phase, respectively, of the main feedback loop of an LDO regulator without the dynamic biasing circuit disclosed herein, when the output load is about 0 mA. A curve 822 and a curve 832 show the loop gain magnitude and phase, respectively, of the main feedback loop of an LDO regulator with the dynamic biasing circuit disclosed herein, when the output load is about 0 mA. A curve 840 and a curve 850 show the loop gain magnitude and phase, respectively, of the main feedback loop of an LDO regulator without the dynamic biasing circuit disclosed herein, when the output load is about 200 mA. A curve 842 and a curve 852 show the loop gain magnitude and phase, respectively, of the main feedback loop of an LDO regulator with the dynamic biasing circuit disclosed herein, when the output load is about 200 mA. As shown by FIG. 8B, when the output load increases, the gain, unity gain frequency, and phase margin of the LDO regulator may be improved. FIG. 8B also shows that adding the dynamic biasing circuit has minimum or no impact on the loop gain, phase margin, and stability of the main feedback loop of the LDO regulator.

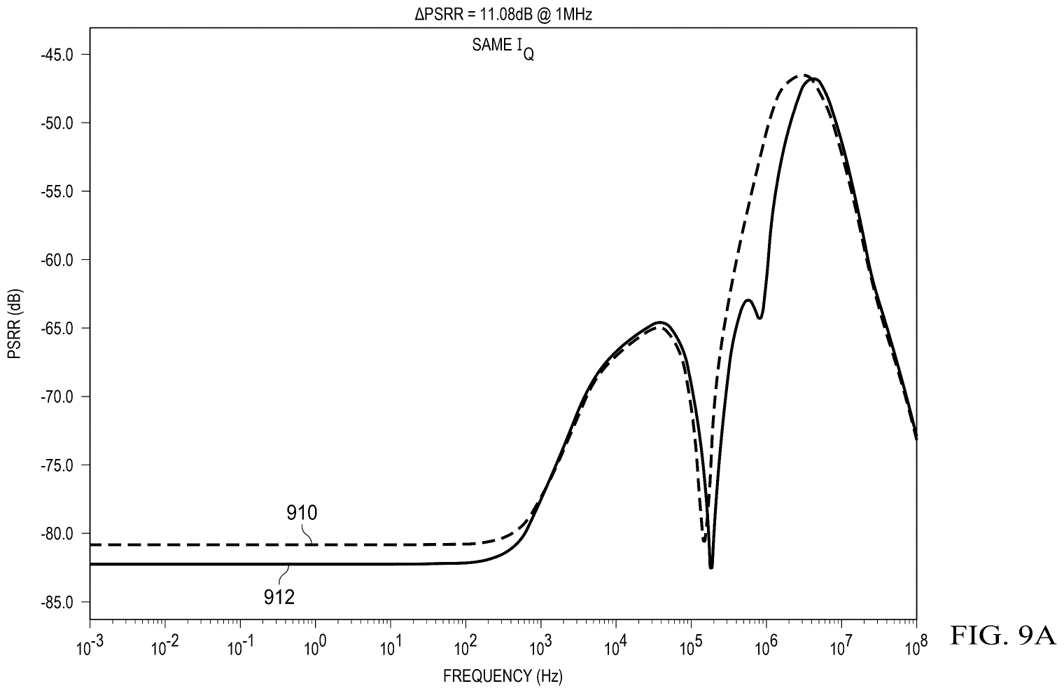

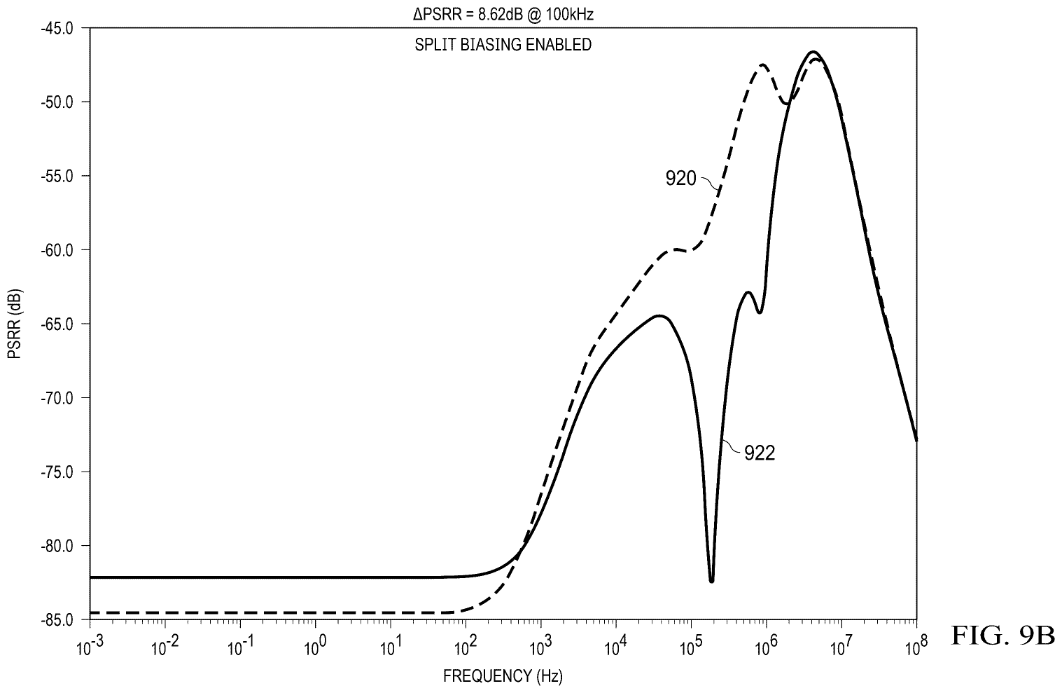

FIGS. 9A and 9B show examples of simulation results for LDO regulators with and without split biasing circuits as described herein. In the illustrated examples, the input voltage V_{IN} of the LDO regulators may be about 4.3 V, the target output voltage V_{OUT} may be about 3.3 V, and the output load may be about 50 mA. A curve 910 in FIG. 9A shows the PSRR of an LDO regulator without bias splitting, where all bias current for the second amplifier stage is provided through a charge pump. A curve 912 in FIG. 9A shows the PSRR of an LDO regulator with the bias splitting disclosed herein (e.g., LDO regulator 400, 500, or 600), where the bias current for the second amplifier stage may mainly be provided from the input voltage and only a small portion of the bias current is provided through the charge pump. FIG. 9A shows that the PSRR of the LDO regulator can be improved significantly at certain frequencies (e.g., about 11 dB at about 1 MHZ) when the bias splitting technique is used. If the bias splitting technique is not used, to achieve the same PSRR, the total quiescent current and the charge pump area may need to be increased significantly if all bias current for the second amplifier stage is supplied from the charge pump.

FIG. 9B shows examples of the simulation results of the PSRR of an LDO regulator with split biasing. A curve 920 shows the PSRR of the LDO regulator without noise cancellation at the level shifter (e.g., transistor 524 or 630). A curve 922 shows the PSRR of the LDO regulator with noise cancellation at the level shifter, for example, in response to a 1V AC signal to the gate of transistor 524 or 630 to cancel noise coupled to the source of transistor 524 or 630. As shown by FIG. 9B, with noise cancelation at the level shifter, the PSRR may be improved significantly at frequencies between a few tens of kilohertz and a few MHz (e.g., about 8.6 dB at about 100 KHz).

As described above, in LDO regulators, Miller compensation may be used to perform pole-splitting and improve the stability of the LDO regulator. A capacitor may be used in the Miller compensation circuit to increase the capacitance at the output of the first amplifier stage, which may have a high output impedance, and thus the dominant pole at the output of the first amplifier stage may have a low frequency and may be separated from non-dominant poles at higher frequencies. The Miller compensation circuit may also include a resistor to move the right-half plane (RHP) zero to the left-half plane (LHP) to become an LHP zero, which may help to negate the effect of the non-dominant poles and increase the unity gain frequency and improve the phase margin. The non-dominant poles may be at different frequencies under different operating conditions. For example, when the load current is high, the transconductance of the pass transistor may be high, and thus a non-dominant pole at the output of the LDO regulator may move to a higher frequency. When the load current is low, the transconductance of the pass transistor may be low, and thus the non-dominant pole at the output of the LDO regulator may move to a lower frequency. Thus, it may be desirable to move the LHP zero with the non-dominant pole, in particular, when the load current is low, in order to improve the stability and unity gain frequency of the LDO regulator.

In some examples, a load-dependent Miller compensation loop that utilizes a current sensor, a current-to-voltage converter, and a voltage-controlled variable resistor may be used to track the load current and move the LHP zero accordingly by tuning the resistance of the variable resistor in the compensation circuit. At a high load current, since the non-dominant pole may move to high frequency and the unity gain frequency may increase, the variable resistor may be controlled to reduce the resistance, thereby moving the LHP zero to a higher frequency. At a low load current, the variable resistor may be controlled to increase the resistance, thereby moving the LHP zero to a lower frequency to negate the effect of a non-dominant pole at the output of the LDO regulator. But this loop may be in conflict with the main feedback loop of the LDO regulator in adjusting the gate voltage of the pass transistor, and thus may degrade the load transient response of the LDO regulator. For example, when the output voltage drops, the main feedback loop may cause the gate voltage of the pass transistor to increase, but the second loop may cause the gate voltage of the pass transistor to drop. In addition, the frequency of the LHP zero set by the variable resistor may not be linearly proportional to the load current. Furthermore, the loop for controlling the Miller compensation resistor may be susceptible to variations in the process and operating conditions (e.g., voltages and temperature). In some examples, low threshold transistors may be needed in order to support low input voltage.

In some examples, to overcome the above-discussed issues in the load-dependent Miller compensation loop, an LDO regulator may include a variable Miller compensation resistor that is controlled based on the load current and output voltage, and a load-dependent Miller compensation loop that includes two loops. The first loop may include a load current sensing circuit and a current-to-voltage conversion circuit to set a voltage that tracks the load current. The second loop may include an amplifier to set the control voltage (e.g., gate voltage) of the Miller compensation resistor based on a difference between the output of the first amplifier stage (which may be associated with the output voltage of the LDO regulator) and the voltage that is set by the first loop to track the load current, such that the control voltage of the Miller compensation resistor may track both the load current and the output of the first amplifier stage (and thus the output voltage of LDO regulator). Therefore, the second loop may reconcile the conflicts between the opposite manners in which the main feedback loop and the first loop of the load-dependent Miller compensation loop control the gate voltage of the pass transistor in response to load transient, and thus can prevent the load-dependent Miller compensation loop and the main feedback loop from changing the gate voltage of the pass transistor in opposite directions, thereby improving the load transient response. This technique may also provide a more precise load-dependent zero that may be proportional to the load current, and may be insensitive to variations in the process and operational conditions, and can be implemented using natural MOS device, which may either use fewer masks than low threshold voltage MOS devices or share masks with other devices in common processes, thereby reducing mask cost.

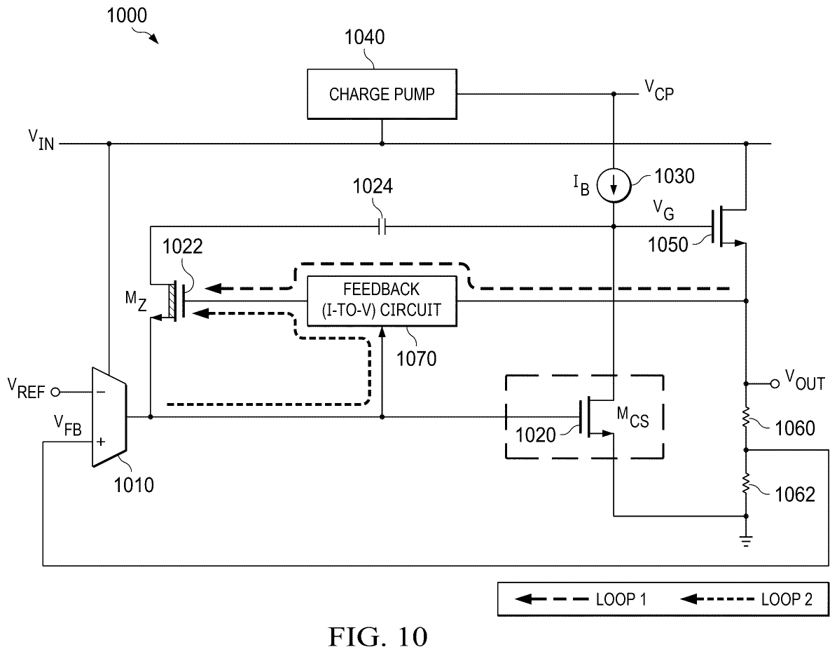

FIG. 10 is a schematic of an example of an LDO regulator 1000 including an adjustable Miller compensation resistor. LDO regulator 1000 may be similar to LDO regulator 100, and may include an additional load-dependent Miller compensation loop that can move the RHP zero to the LHP to become an LHP zero, and move the LHP zero with the load-dependent non-dominant pole to improve the stability and unity gain frequency of the LDO regulator, in particular, when the load current is low. The load-dependent Miller compensation loop may include a feedback circuit 1070 that may sense the load current and generate a corresponding control signal to control a transistor for Miller compensation, such that the resistance of the Miller compensation resistor can vary with the load current, thereby changing the frequency of the LHP zero that may help to negate the effect of non-dominant poles.

In the illustrated example, LDO regulator 1000 may include an N-type pass transistor 1050, an amplifier that may include a first amplifier stage 1010 and a second amplifier stage 1020. First amplifier stage 1010 may include a differential amplifier. Second amplifier stage 1020 may be implemented using, for example, an NFET transistor configured as a common-source amplifier (or NPN configured as a common-emitter). LDO regulator 1000 may also include a Miller compensation circuit that may include a variable resistor 1022 (e.g., a transistor) and a capacitor 1024. LDO regulator 1000 may further include an output feedback scaling circuit that may include a resistor 1060 and a resistor 1062. LDO regulator 1000 may further include a charge pump 1040 and a biasing circuit 1030 (e.g., a current source) for driving pass transistor 1050 and second amplifier stage 1020. In addition, LDO regulator 1000 may include feedback circuit 1070 that may sense the load current at the output of LDO regulator 1000 and control variable resistor 1022 accordingly to change the resistance of variable resistor 1022, thereby changing the frequency of the LHP zero according to the load current.

Pass transistor 1050 may have a drain coupled to an input voltage V_{IN}, a source coupled to a voltage output port of LDO regulator 1000, and a gate coupled to the output of second amplifier stage 1020. Thus, pass transistor 1050 may be controlled by the amplifier based on the output voltage of LDO regulator 1000. Pass transistor 1050 may be an NFET/NPN transistor that can provide the desired current drive capability with a relatively small area on the semiconductor die, and can have a smaller parasitic gate capacitor that can be charged at a high rate and/or with a smaller current. To provide an output voltage V_{OUT} that is close to input voltage V_{IN}, the voltage level at the gate of pass transistor 1050 may need to be higher than the input voltage because a voltage difference between the gate and source of pass transistor 1050 needs to be greater than the threshold voltage V_{T} of pass transistor 1050 in order to turn on pass transistor 1050. The higher voltage level at the gate of pass transistor 1050 may be supplied by charge pump 1040 or another voltage boost circuit, such as a bootstrap circuit. Charge pump 1040 may receive input from input voltage V_{IN}, and may store the energy (e.g., using capacitors) to provide an output voltage V_{CP} that is higher than input voltage V_{IN}. As shown in FIG. 10, the output voltage V_{CP} of charge pump 1040 may be used to drive a biasing circuit 1030 (e.g., a current source) to set the voltage level at the gate of pass transistor 1050. The output of charge pump 1040 may also be used to bias second amplifier stage 1020, the output of which is coupled to the gate of pass transistor 1050. As described above, charge pump 1040 may have power loss and may need an input current that is a few times higher than the output current of charge pump 1040 due to the voltage up-conversion and power loss.

The amplifier may drive pass transistor 1050 based on a difference between a feedback voltage V_{FB} and a reference voltage V_{REF} to regulate the output voltage V_{OUT}. The reference voltage may be from, for example, a bandgap voltage reference or another reference voltage generation circuit. The feedback voltage V_{FB} may be a fraction of the output voltage V_{OUT}. The values of resistors 1060 and 1062 may be selected based on the voltage levels of the reference voltage and the target output voltage, to set the desired voltage dividing ratio of the voltage divider formed by resistor 1060 and 1062. First amplifier stage 1010 may include a differential amplifier that is powered by, for example, input voltage V_{IN}, and may amplify the difference between feedback voltage V_{FB} and reference voltage V_{REF}. The output of first amplifier stage 1010 may be used as an input to second amplifier stage 1020, which may perform the voltage level shifting between the output of first amplifier stage 1010 and the gate of pass transistor 1050. In the illustrated example, second amplifier stage 1020 may include a common-source amplifier formed by an NFET transistor. The gate of the NFET transistor may be coupled to the output of first amplifier stage 1010, the source of the NFET transistor may be coupled to ground, whereas the drain of the NFET transistor may be coupled to biasing circuit 1030 and the gate of pass transistor 1050. Second amplifier stage 1020 may function as a buffer to isolate the output of first amplifier stage 1010 and the gate of pass transistor 1050, such that a pole at the gate of pass transistor 1050 and a pole at the output of first amplifier stage 1010 may be separate.

The output voltage V_{OUT} may change when, for example, the input voltage V_{IN} changes, and/or the load current at the output of LDO regulator 1000 changes. When the output voltage V_{OUT} is lower than the target output voltage, the positive input of first amplifier stage 1010 may decrease, and thus the output voltage of first amplifier stage and the gate voltage of the NFET transistor of second amplifier stage 1020 may decrease as well, such that the drain current of the NFET transistor of second amplifier stage 1020 may decrease and the voltage drop across the NFET transistor of second amplifier stage 1020 may increase. Therefore, the voltage level at the gate of pass transistor 1050 may increase, thereby increasing the drain current of pass transistor 1050 to pull up the output voltage V_{OUT}. When the output voltage V_{OUT} is higher than the target output voltage, the voltage level at the positive input of first amplifier stage 1010 may increase, and thus the output voltage of first amplifier stage 1010 and the gate voltage of the NFET transistor of second amplifier stage 1020 may increase as well. The higher gate voltage of the NFET transistor of second amplifier stage 1020 may cause the drain current of the NFET transistor to increase, such that the gate capacitor of pass transistor 1050 may be discharged more quickly through the NFET transistor of second amplifier stage 1020, and thus the voltage level at the gate of pass transistor 1050 may decrease. The decrease of the gate voltage of pass transistor 1050 may cause the drain current of pass transistor 1050 to decrease, thereby decreasing the output voltage V_{OUT}.

To increase the unity gain frequency and load transient response performance while improving the phase margin and stability of LDO regulator 1000, variable resistor 1022 and capacitor 1024 of the Miller compensation circuit may be connected in series between the output of first amplifier stage 1010 and the gate of pass transistor 1050 (and the output of second amplifier stage 1020). First amplifier stage 1010 may have a high output impedance, and thus a pole at the output of first amplifier stage 1010 may be a dominant pole at a low frequency due to the high output impedance and capacitor 1024 of the Miller compensation circuit. The second amplifier stage 1020 may be biased at a high bias current and thus may have a high transconductance, and the gate capacitance of NFET pass transistor 1050 may be small, such that a pole at the output of second amplifier stage 1020 and the gate of pass transistor 1050 may be a non-dominant pole at a higher frequency. In addition, a pole at the output of LDO regulator 1000 may be another non-dominant pole, the frequency of which may depend on the load current of LDO regulator 1000. For example, when the load current high, pass transistor 1050 may have a high transconductance, and thus the frequency of the non-dominant pole at the output of LDO regulator 1000 may be high. When the load current is lower, pass transistor 1050 may have a lower transconductance, and thus the frequency of the non-dominant pole at the output of LDO regulator 1000 may decrease. The separation of the dominant pole and the non-dominant poles may increase the unity gain frequency and the phase margin at the unity gain frequency. In addition, variable resistor 1022 of the Miller compensation circuit may be used to set the frequency of LHP zero to track a non-dominant pole (e.g., the non-dominant pole at the output of LDO regulator 1000), which may help to negate the effect the non-dominant pole, thereby increasing the unity gain frequency and improving the stability of LDO regulator 1000.

As illustrated in FIG. 10, the load-dependent Miller compensation loop may include feedback circuit 1070 that may sense the load current and generate a corresponding control voltage signal to control variable resistor 1022. Feedback circuit 1070 may also sense the output voltage of first amplifier stage 1010 and generate the control voltage signal based in part on the output voltage of first amplifier stage 1010. Therefore, the load-dependent Miller compensation loop may include two loops as indicated in FIG. 10. The first loop (loop 1) may include a current sensing and current-to-voltage conversion circuit (e.g., part of feedback circuit 1070) to set a voltage level that tracks the load current. The second loop (loop 2) may include an amplifier (e.g., part of feedback circuit 1070) that sets the control voltage based on a difference between the output voltage of first amplifier stage 1010 (which may depend on the output voltage of LDO regulator 1000) and the voltage level set by the first loop based on the load current. The second loop may prevent the first loop and the main feedback loop from changing the gate voltage of pass transistor 1050 in opposite directions, thereby improving the load transient response.

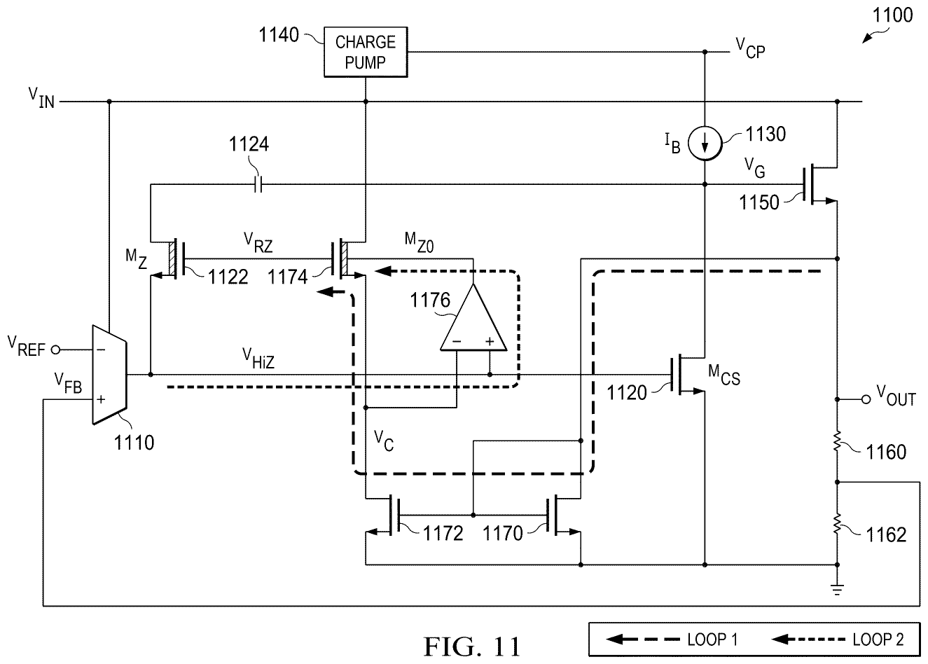

FIG. 11 is a schematic of an example of an LDO regulator 1100, which may be an example of LDO regulator 1000 of FIG. 10. As LDO regulator 1000, LDO regulator 1100 may include an N-type pass transistor 1150 (e.g., NFET or NPN) and an amplifier that may include a first amplifier stage 1110 and a second amplifier stage 1120. First amplifier stage 1110 may include a differential amplifier. Second amplifier stage 1120 may be implemented using, for example, an NFET transistor configured as a common-source amplifier. LDO regulator 1100 may also include an output feedback scaling circuit that may include a voltage divider formed by a resistor 1160 and a resistor 1162. The amplifier, the output feedback scaling circuit, and pass transistor 1150 may form a main feedback loop for regulating the output voltage V_{OUT} of LDO regulator 1100. LDO regulator 1100 may further include a charge pump 1140 and a biasing circuit 1130 (e.g., a current source) for driving pass transistor 1150 and second amplifier stage 1120. These components may function in manners similar to the corresponding components of, for example, LDO regulator 200, 300, or 1000 described above, and thus are not described in detail again with respect to FIG. 11.

As illustrated, LDO regulator 1100 may also include a Miller compensation circuit that may include a transistor 1122 and a capacitor 1124. LDO regulator 1100 may further include an amplifier 1176 and transistors 1170, 1172, and 1174 that may be used to control the gate voltage of transistor 1122 based on the output voltage and output load current of LDO regulator 1100. Transistors 1170, 1172, and 1174 may be part of a first loop (loop 1) of the load-dependent Miller compensation loop described above with respect to FIG. 10. Amplifier 1176 may be part of the second loop (loop 2) of the load-dependent Miller compensation loop described above with respect to FIG. 10.

In the first loop, the load current at the output of LDO regulator 1100 may be sensed and mirrored from transistor 1170 to transistor 1172 and transistor 1174, such that the voltage level V_{C} at the source of transistor 1174 and the drain of transistor 1172 may be a function of the load current. Because the gate of transistor 1122 is connected to the gate of transistor 1174, if the source of transistor 1122 and the source of transistor 1174 are also at a same voltage level, the drain current of transistor 1174 may be mirrored to transistor 1122 so that the frequency of the LHP zero (after being moved from the RHP) that may depend on the operation condition of transistor 1122 may be a function (e.g., a linear function) of the load current. For example, when the load current is lower, the current mirrored to transistor 1122 may be lower, and thus the LHP zero may be at a lower frequency to negate the effect of the non-dominant pole at a lower frequency at the output of LDO regulator 1100. When the load current is higher, the current mirrored to transistor 1122 may be higher, and thus the LHP zero may be at a higher frequency to negate the effect of the non-dominant pole at a higher frequency at the output of LDO regulator 1100.

As described above, when the output voltage of LDO regulator 1100 decreases due to, for example, an increase of the load current, the output of the first amplifier stage 1110 of the main feedback loop may decrease as well, such that the drain current of the NFET transistor of second amplifier stage 1120 may decrease and the gate voltage of pass transistor 1150 may increase, thereby increasing the load current and pulling up the output voltage. However, when the output of the first amplifier stage 1110 of the main feedback loop decreases, the drain current of transistor 1122 may increase due to a larger V_{GS} at transistor 1122, and the gate voltage of pass transistor 1150 may be decreased due to the increase in the current that flows through transistor 1122 to charge capacitor 1124 and discharging the gate capacitor of pass transistor 1150. Therefore, the main feedback loop and the first loop of the load-dependent Miller compensation loop may change the gate voltage of pass transistor 1150 oppositely during the load transient. This conflict may be reconciled by the second loop of the load-dependent Miller compensation loop as described in detail below.

In the second loop, amplifier 1176 is used to regulate the gate voltage of transistors 1122 and 1174 and the source voltage of transistor 1174 based on the source voltage of transistor 1122 (e.g., output voltage of first amplifier stage 1110), such that the gate voltage of transistors 1122 and 1174 may track both the output voltage of first amplifier stage 1110 (and thus the output voltage of LDO regulator 1100) and the source voltage of transistor 1174 (and thus the load current), and the source voltage of transistor 1122 and the source voltage of transistor 1174 may be approximately equal. For example, if the output voltage of the first amplifier stage 1110 (and output voltage of LDO regulator 1100) decreases, the output voltage of amplifier 1176 and thus the gate voltage of transistor 1174 may also decrease to decrease the source voltage of transistor 1174, such that the source voltage of transistor 1174 and the source voltage of transistor 1122 may be approximately equal, so that the sensed load current can be more accurately mirrored to transistor 1122 through transistor 1174. As a result, the drain current of transistor 1122 may be similar to the drain current of transistor 1174, even if there may be variations in the manufacturing process and operating conditions (e.g., operating voltage and temperature). Therefore, the load-dependent LHP zero may be precisely set based on the load current (e.g., proportional to the load current). The second loop may also allow the use of natural MOS device, which may either use fewer masks than low threshold voltage MOS devices or share masks with other devices in common processes, thereby reducing mask cost.

In addition, as shown in FIG. 11, when the output voltage of the first amplifier stage 1110 (and output voltage of LDO regulator 1100) decreases, the output voltage of amplifier 1176 and thus the gate voltage of transistors 1122 and 1174 may also decrease to decrease the drain current of transistor 1122 so that the gate voltage of pass transistor 1150 may not be decreased due to the discharging (and charging of capacitor 1124) through transistor 1122. Therefore, the second loop can mitigate the undesired effect of the first loop to improve the load transient response. For example, when the load current is increased form a low value to a high value, the output voltage of the LDO regulator may decrease, which may cause the output voltage of first amplifier stage 1110 and the output voltage of amplifier 1176 to decrease. Therefore, the gate voltage of transistor 1122 may be decreased such that the drain current of transistor 1122 may be reduced or transistor 1122 may be turned off and may not draw current from biasing circuit 1130 and the gate of pass transistor 1150. As such, the gate voltage of pass transistor 1150 may not be reduced by the first loop when the load increases and the output voltage decreases.

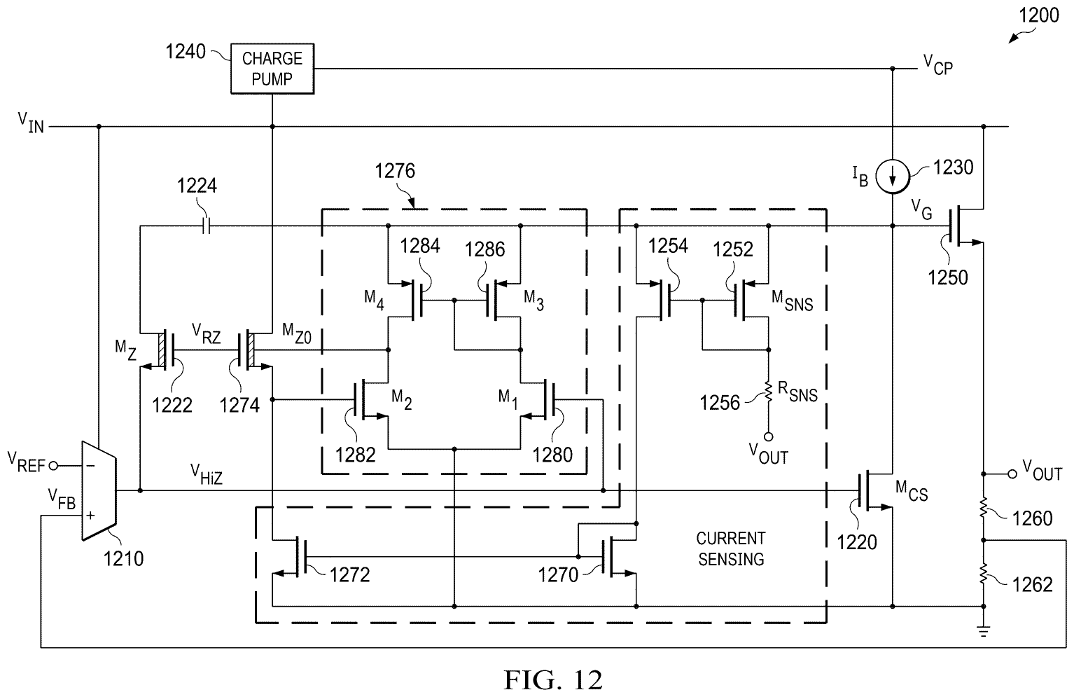

FIG. 12 is a schematic of an example of an LDO regulator 1200. LDO regulator 1200 may be an example of LDO regulator 1000 or 1100. As LDO regulator 1100, LDO regulator 1200 may include an N-type pass transistor 1250 (e.g., NFET or NPN) and an amplifier that may include a first amplifier stage 1210 and a second amplifier stage 1220. First amplifier stage 1210 may include a differential amplifier. Second amplifier stage 1220 may be implemented using, for example, an NFET transistor configured as a common-source amplifier (or an NPN transistor configured as a common-emitter amplifier). LDO regulator 1200 may also include an output feedback scaling circuit that may include a voltage divider formed by a resistor 1260 and a resistor 1262. The amplifier, the output feedback scaling circuit, and pass transistor 1250 may form a main feedback loop for regulating the output voltage V_{OUT} of LDO regulator 1200. LDO regulator 1200 may further include a charge pump 1240 and a biasing circuit 1230 (e.g., a current source) for driving pass transistor 1250 and second amplifier stage 1220. LDO regulator 1200 may also include a Miller compensation circuit that may include a transistor 1222 and a capacitor 1224. LDO regulator 1200 may further include an amplifier 1276 and transistors 1270, 1272, and 1274 that may be used to control the gate voltage of transistor 1222 based on the output voltage and output load current of LDO regulator 1200. Transistors 1270, 1272, and 1274 may be part of a first loop (loop 1) of the load-dependent Miller compensation loop described above with respect to FIGS. 10 and 11. Amplifier 1276 may be part of the second loop (loop 2) of the load-dependent Miller compensation loop described above with respect to FIGS. 10 and 11. These components may function in manners similar to the corresponding components of, for example, LDO regulator 1000 or 1100 described above, and thus are not described in detail again with respect to FIG. 12.

FIG. 12 shows an example of an implementation of amplifier 1276, which may be a differential amplifier including four transistors 1280, 1282, 1284, and 1286, without using a biasing circuit. Even though FIG. 12 shows that transistors 1284 and 1286 are connected to the output of charge pump through biasing circuit 1230, transistors 1284 and 1286 may be connected to the input voltage V_{IN} in other examples. Transistors 1280 may have the same gate and source voltages as the NFET transistor of second amplifier stage 1220, and thus may have a drain current that is proportional to the drain current of the NFET transistor of second amplifier stage 1220. Therefore, no additional bias current is needed for amplifier 1276. The effective bias current of amplifier 1276 may depend on the size ratio between transistor 1280 and the NFET transistor of second amplifier stage 1220.

FIG. 12 also shows an example of an implementation of a load current sensing circuit that may include transistors 1252 and 1254 (which form a current mirror) and a resistor 1256. Resistor 1256 may be connected to the source of pass transistor 1250 (output of LDO regulator 1200) and the drain and gate of transistor 1252. The source of transistor 1252 may be connected to the gate of pass transistor 1250. Therefore, the voltage across resistor 1256 and transistor 1252 may be equal to the voltage difference V_{GS} between the gate and the source of pass transistor 1250, where the V_{GS} of pass transistor 1250 may indicate the drain current of pass transistor 1250. The difference between the V_{GS} of pass transistor 1250 and the V_{GS} (or V_{DS}) of transistor 1252 may be the voltage drop on resistor 1256. Therefore, the drain current of transistor 1252 may be equal to the difference between the V_{GS} of pass transistor 1250 and the V_{DS} of transistor 1252 divided by the resistance of resistor 1256, thus may indicate the load current (or the change of the load current) of LDO regulator 1200. The drain current of transistor 1252 may then be mirrored to transistors 1254 and 1270, and eventually mirrored to transistor 1222 through a pair of current mirror formed by transistor 1270 and 1272 and a pair of current mirror formed by transistor 1272 and 1222, as described above with respect to FIG. 11.

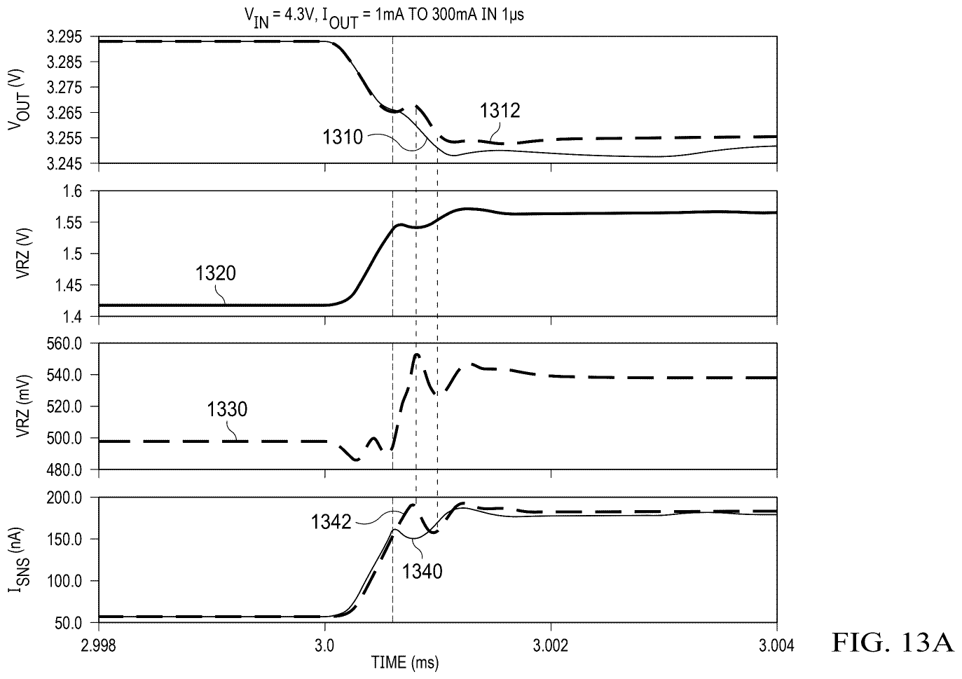

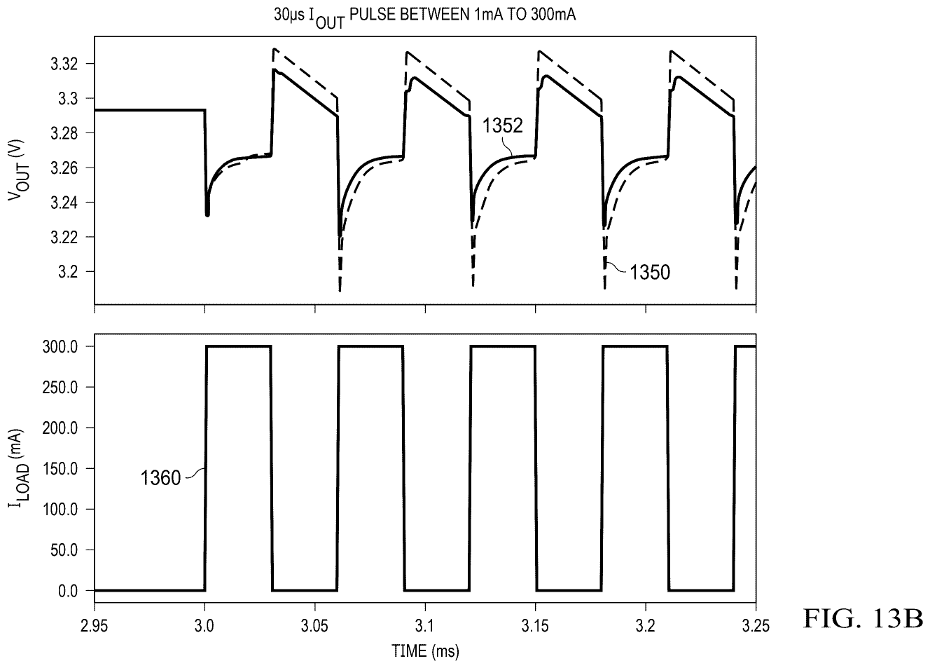

FIGS. 13A and 13B are graphs showing examples of simulation results for LDO regulators with and without the examples of adjustable Miller compensation resistor as described herein. In the examples shown in FIGS. 13A and 13B, the input voltage V_{IN} of the LDO regulators may be about 4.3 V, and the target output voltage V_{OUT} may be about 3.3 V. In the first example, a first LDO regulator may be similar to LDO regulator 1000, 1100, or 1200, but may not have the second loop of the load-dependent Miller compensation loop. In the second example, a second LDO regulator may be similar to LDO regulator 1000, 1100, or 1200, and may have both the first loop and second loop of the load-dependent Miller compensation loop described above.

In the examples shown in FIG. 13A, the output load may have a step change from about 1 mA to about 300 mA in about 1 μs. A curve 1310 shows an example of the output voltage of the first LDO regulator. A curve 1320 shows the gate voltage of the Miller compensation resistor (e.g., variable resistor 1022, transistor 1122, or transistor 1122) of the first LDO regulator. A curve 1340 shows an example of the sensed load current of the first LDO regulator, which may be a fraction of the load current of the first LDO regulator. A curve 1312 shows an example of the output voltage of the second LDO regulator. A curve 1330 shows the gate voltage of the Miller compensation resistor (e.g., variable resistor 1022, transistor 1122, or transistor 1122) of the second LDO regulator. A curve 1342 shows an example of the sensed load current of the second LDO regulator, which may be a fraction of the load current of the second LDO regulator.

In the examples of simulation results shown in FIG. 13B, the output load may include a series of short pulses with a period about 60 μs and a pulse width about 30 μs, as shown by a curve 1360. Each pulse may include a rising edge from about 1 mA to about 300 mA, and a falling edge from about 300 mA to about 1 mA. A curve 1350 shows the output voltage of the first LDO regulator, whereas a curve 1352 shows the output voltage of the second LDO regulator.

As illustrated by FIGS. 13A and 13B, in the second LDO regulator with the second loop of the load-dependent Miller compensation loop, the gate voltage of the Miller compensation resistor may better track the output voltage of the LDO regulator, and the well-regulated LHP zero may help to improve load transient response. For example, FIG. 13B shows that the undershoot in the output voltage of the second LDO regulator may be more than about 30% lower than the undershoot in the output voltage of the first LDO regulator, at least partially because the second loop may mitigate the undesired change of the gate voltage of the pass transistor by the first loop that may be opposite to the change of the gate voltage of the pass transistor by the main feedback loop.

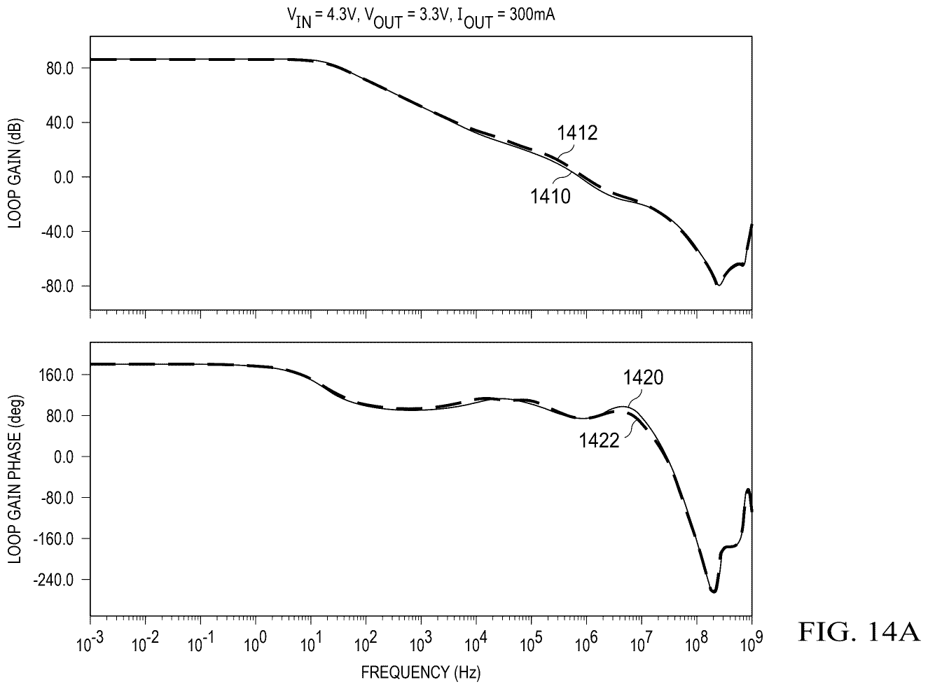

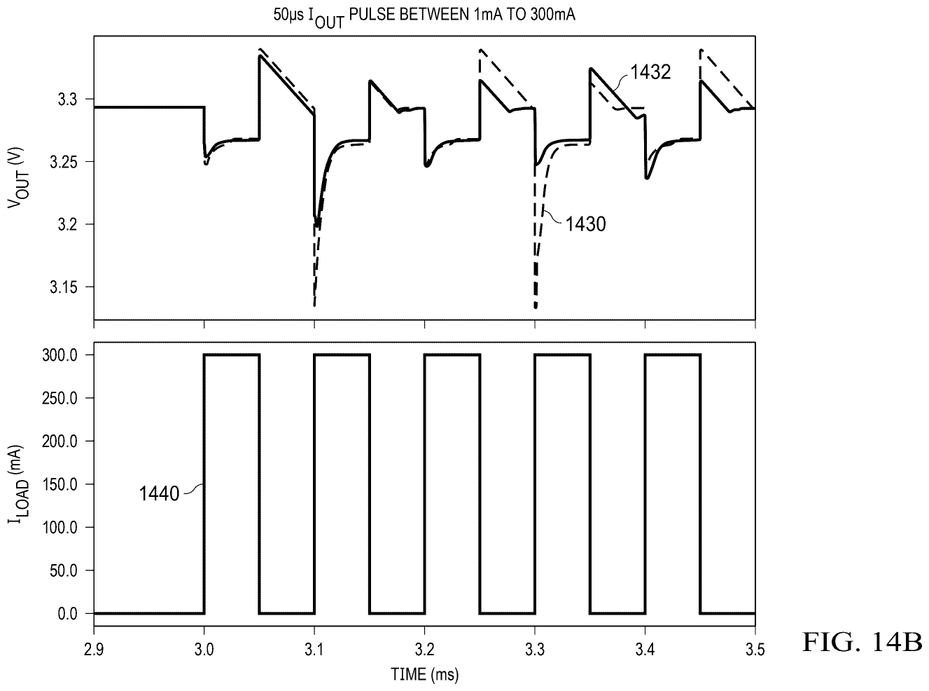

FIGS. 14A and 14B are graphs showing examples of simulation results for LDO regulators with and without the examples of adjustable Miller compensation resistor as described herein. In the examples shown in FIGS. 14A and 14B, the input voltage V_{IN} of the LDO regulators may be about 4.3 V, and the target output voltage V_{OUT} may be about 3.3 V. In the first example, a first LDO regulator may be similar to LDO regulator 1000, 1100, or 1200, but may not have the second loop of the load-dependent Miller compensation loop. In the second example, a second LDO regulator may be similar to LDO regulator 1000, 1100, or 1200, and may have both the first loop and second loop of the load-dependent Miller compensation loop described above.

In the examples shown in FIG. 14A, a curve 1410 shows the magnitude of the small-signal loop gain of the first LDO regulator. A curve 1420 shows the phase of the small-signal loop gain of the first LDO regulator. A curve 1412 shows the magnitude of the small-signal loop gain of the second LDO regulator. A curve 1422 shows the phase of the small-signal loop gain of the second LDO regulator.

In the examples shown in FIG. 14B, the output load may include a series of short pulses with a period about 100 μs and a pulse width about 50 μs, as shown by a curve 1440. Each pulse may include a rising edge from about 1 mA to about 300 mA, and a falling edge from about 300 mA to about 1 mA. A curve 1430 shows the output voltage of the first LDO regulator, whereas a curve 1432 shows the output voltage of the second LDO regulator.

As illustrated, the second LDO regulator with the second loop of the load-dependent Miller compensation loop may have similar small-signal loop stability as the first LDO regulator, but may still improve the load transient response compared with the first LDO regulator. For example, as illustrated in FIG. 14B, the undershoot in the output voltage of the second LDO regulator may be more than 40% lower than the undershoot in the output voltage of the first LDO regulator.

In some examples, an LDO regulator may implement two or more of the techniques disclosed herein, including the output voltage controlled dynamic biasing circuit, split biasing circuits for reducing charge pump current, and additional loop for load-dependent Miller compensation to control the resistance of the variable Miller compensation resistor using a voltage signal that tracks both the load current and the output voltage of the first amplifier stage. As such, as described above and below, the LDO regulators disclosed herein may have small device area, low quiescent current, fast response to load transient, low complexity, low current from charge pump, high PSRR, and lower output noise, and may be less sensitive to variations in process and operating conditions.

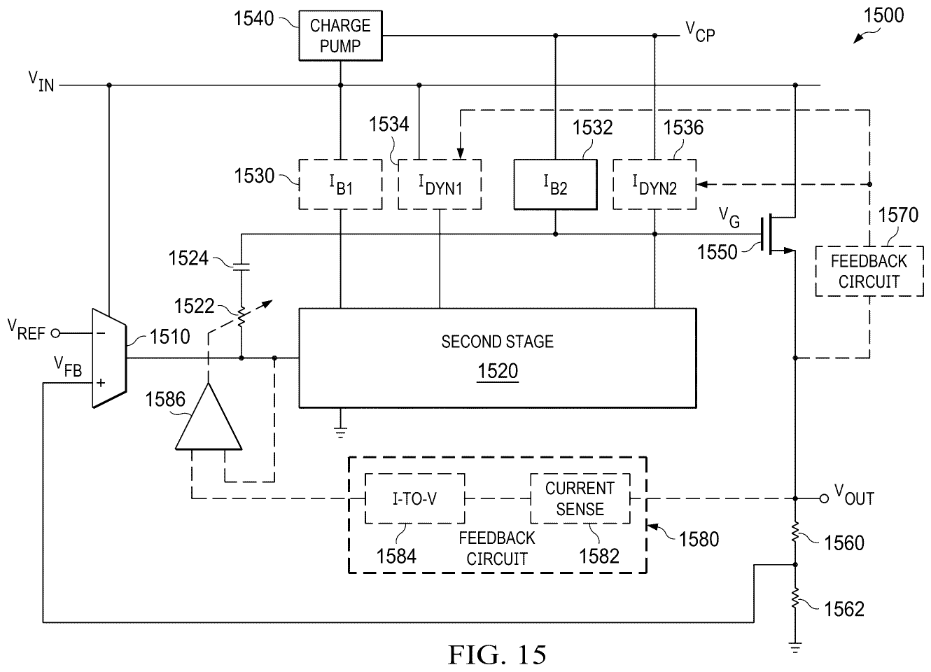

FIG. 15 is a schematic of an example of an LDO regulator 1500 incorporating various combinations of techniques as described herein. LDO regulator 1500 may include the load-dependent Miller compensation loop described above with respect to, for example, FIGS. 10-12, and the split biasing circuits that may also include an adjustable dynamic biasing circuit as described above with respect to, for example, FIGS. 2-6. In the example illustrated in FIG. 15, LDO regulator 1500 may include a pass transistor 1550 and an amplifier that may include a first amplifier stage 1510 and a second amplifier stage 1520. First amplifier stage 1510 may include a differential amplifier. Second amplifier stage 1520 may be implemented using, for example, an NFET transistor configured as a common-source amplifier (as shown in, e.g., FIGS. 2, 3, and 10-12), or may include an NFET transistor configured as a common-source amplifier and a level shifter (as shown in, e.g., FIGS. 4-6). LDO regulator 1500 may also include an output feedback scaling circuit that may include a voltage divider formed by a resistor 1560 and a resistor 1562. The amplifier, the output feedback scaling circuit, and pass transistor 1550 may form a main feedback loop for regulating the output voltage V_{OUT} of LDO regulator 1500. LDO regulator 1500 may further include a charge pump 1540 for driving pass transistor 1550 and second amplifier stage 1520.

As illustrated, LDO regulator 1500 may also include a Miller compensation circuit that may include a variable resistor 1522 (e.g., implemented using a transistor) and a capacitor 1524. LDO regulator 1500 may further include a feedback circuit 1580 and an amplifier 1586 for controlling variable resistor 1522 based on the load current and the output of the first amplifier stage 1510. Feedback circuit 1580 may include a current sensing circuit 1582 configured to sense the load current of LDO regulator 1500 (e.g., by sensing the V_{GS} of pass transistor 1550), such as the current sensing circuit described above with respect to FIG. 12. Feedback circuit 1580 may also include a current-to-voltage converter 1584 that may set a voltage that tracks the load current as described above with respect to FIG. 12. Amplifier 1586 may generate a control voltage for controlling variable resistor 1522 based on the output of the first amplifier stage 1510 and the voltage that tracks the load current. In this way, the LHP zero of LDO regulator 1500 may be controlled by controlling the resistance of variable resistor 1522 based on the load current to track the non-dominant pole at the output of LDO regulator 1500. The resistance of variable resistor 1522 may also be controlled based on the output voltage to improve the load transient response and PSRR of LDO regulator 1500, as described above with respect to FIG. 12. As also described above, this technique may also be insensitive to variations in the process and operational conditions, and can be implemented using natural MOS device, which may either use fewer masks than low threshold voltage MOS devices or share masks with other devices in common processes, thereby reducing mask cost.

LDO regulator 1500 may also include split biasing circuits that may include a first biasing circuit 1530 and a second biasing circuit 1532 for driving second amplifier stage 1520, as described above with respect to, for example, FIGS. 4-6. First biasing circuit 1530 may be coupled to and receive current from the input voltage. Second biasing circuit 1532 may be coupled to and receive current from charge pump 1540. In this way, the current supplied by charge pump 1540 may be reduced, and the power loss and size of LDO regulator 1500 may be reduced. In addition, the first biasing circuit 1530 can be designed to provide a large current to move the non-dominant pole at the gate of pass transistor 1550 to a higher frequency, thereby increasing the unity gain frequency and improving the stability and load transient response of LDO regulator 1500.

In some examples, LDO regulator 1500 may also include dynamic biasing circuits that may provide bias currents based on the output voltage or load of LDO regulator 1500, as described above with respect to, for example, FIGS. 2, 3, and 6. For example, as described above with respect to FIG. 6, the dynamic biasing circuit may include a third biasing circuit 1534 and a fourth biasing circuit 1536 that may be controlled by a feedback circuit 1570, where third biasing circuit 1534 may be coupled to and receive current from the input voltage and fourth biasing circuit 1536 may be coupled to and receive current from charge pump 1540. Third biasing circuit 1534 and fourth biasing circuit 1536 may be turned off during the steady-state operations of LDO regulator 1500, and may be turned on to provide more bias current when the output voltage decreases due to, for example, an increase in the load of LDO regulator 1500. In this way, the load transient response and PSRR of LDO regulator 1500 may be improved.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of at least a part of Y and any number of other factors. If an action X is “based on” Y, then the action X may be based at least in part on at least a part of Y.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current I_{D} (or drain-to-source current I_{DS}) may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

In this description, unless otherwise stated, “about,” “approximately” or “substantially” preceding a parameter means being within +/−10 percent of that parameter or, if the parameter is zero, a reasonable range of values around zero.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Although various examples have been described in detail, it should be understood that various changes, substitutions, and alterations can be made therein without departing from the scope defined by the appended claims. The devices, structures, materials, and processes discussed above are examples. Various examples may omit, substitute, or add various procedures or components as appropriate. Also, features described with respect to certain examples may be combined in various other examples. Different aspects and elements of the examples may be combined in a similar manner. Also, technology evolves and, thus, many of the elements are examples that do not limit the scope of the disclosure to those specific examples.

Specific details are given in the description on order to provide a thorough understanding of the examples. However, examples may be practiced without these specific details. For example, well-known circuits, processes, systems, structures, and techniques may have been shown without unnecessary detail in order to avoid obscuring the examples. This description provides examples only, and is not intended to limit the scope, applicability, or configuration of the invention. Rather, the preceding description of the examples will provide those skilled in the art with an enabling description for implementing various examples. Various changes may be made in the function and arrangement of elements without departing from the spirit and scope of the present disclosure. Modifications are possible in the described examples, and other examples are possible, within the scope of the claims.

What is claimed is:

1. An apparatus comprising:
a first transistor coupled between a power input and a power output, the first transistor being an N-type transistor and having a first transistor control input;
a first amplifier stage having a reference input, a feedback input, and a first amplifier output, the feedback input coupled to the power output;
a second amplifier stage having an amplifier input and a second amplifier output, the amplifier input coupled to the first amplifier output, and the second amplifier output coupled to the first transistor control input; and
a first biasing circuit coupled to the first transistor control input, the first biasing circuit having an electrical control input coupled to the power output.

2. The apparatus of claim 1, wherein the second amplifier stage includes a second transistor, the second transistor having a second transistor control input coupled to the amplifier input and a current input coupled to the second amplifier output.

3. The apparatus of claim 1, further comprising a voltage boost circuit coupled to the power input and including a boost voltage output, wherein the first biasing circuit is coupled between the boost voltage output and the first transistor control input.

4. The apparatus of claim 3, wherein the voltage boost circuit includes at least one of a charge pump circuit or a bootstrap circuit.

5. The apparatus of claim 3, further comprising a second biasing circuit coupled between the boost voltage output and the second amplifier output.

6. The apparatus of claim 1, further comprising a feedback circuit electrically coupling the power output to the electrical control input of the first biasing circuit.

7. The apparatus of claim 6, wherein the feedback circuit includes:
a negative feedback circuit having a negative input, a positive input coupled to the reference input, and a feedback output coupled to the electrical control input of the first biasing circuit; and
a high-pass filter coupled between the power output and the negative input.

8. The apparatus of claim 7, wherein:
the negative feedback circuit includes a differential amplifier; and
the high-pass filter includes a capacitor.

9. The apparatus of claim 7, wherein the feedback circuit further includes:
a first voltage scaling circuit coupling the reference input to the positive input; and
a second voltage scaling circuit coupling the power output to the negative input.

10. The apparatus of claim 1, wherein the first biasing circuit includes a current mirror having a gain ratio greater than one.

11. The apparatus of claim 1, wherein:
the second amplifier stage includes a buffer and a level shifter;
the buffer includes a buffer input, a buffer output, and a bias input, the buffer input coupled to the first amplifier output;
the level shifter includes a level shifter input coupled to the buffer output, and a level shifter output coupled to the second amplifier output; and
the apparatus further comprises a second biasing circuit coupled between the power input and the bias input of the buffer.

12. The apparatus of claim 11, wherein the level shifter includes a second transistor coupled between the buffer output and the second amplifier output, the second transistor including a second transistor control input coupled to the power input.

13. The apparatus of claim 11, wherein the buffer includes a second transistor having a second transistor control input coupled to the amplifier input, and a current input coupled to the bias input.

14. The apparatus of claim 11, further comprising a feedback circuit coupled between the power output and a bias control input of the second biasing circuit.

15. The apparatus of claim 14, wherein the second biasing circuit includes a current mirror having a gain ratio greater than one.

16. The apparatus of claim 1, further comprising a compensation circuit coupled between the first amplifier output and the second amplifier output, the compensation circuit including a capacitive element and a resistive element connected in series between the first amplifier output and the first transistor control input.

17. The apparatus of claim 16, wherein:
the resistive element includes a second transistor having a second transistor control input coupled to the power output; and
the apparatus further comprises a feedback circuit coupling the power output to the second transistor control input.

18. The apparatus of claim 17, wherein the feedback circuit includes:
a current sensing circuit coupled to the power output; and
a current-to-voltage conversion circuit coupled between the current sensing circuit and the second transistor control input.

19. The apparatus of claim 18, wherein the current-to-voltage conversion circuit includes:
a third transistor having a current terminal coupled to an output of the current sensing circuit, the third transistor having a third transistor control input coupled to the second transistor control input; and
a differential amplifier having a positive input, a negative input, and a third amplifier output, the positive input coupled to the first amplifier output, the negative input coupled to the current terminal of the third transistor, and the third amplifier output coupled to the second transistor control input and the third transistor control input.

20. An apparatus comprising:
a first transistor coupled between a power input and a power output, the first transistor being an N-type transistor and having a first transistor control input;
a first amplifier stage having a reference input, a feedback input, and a first amplifier output, the feedback input coupled to the power output;
a second amplifier stage having an amplifier input and a second amplifier output, the amplifier input coupled to the first amplifier output, and the second amplifier output coupled to the first transistor control input; and
a capacitor and a second transistor coupled in series between the first amplifier output and the first transistor control input, the second transistor having a second transistor control input electrically coupled to the power output and the first amplifier output.

21. The apparatus of claim 20, further comprising a feedback circuit coupling the power output and the first amplifier output to the second transistor control input.

22. An apparatus comprising:
a transistor coupled between a power input and a power output, the transistor being an N-type transistor and having a transistor control input;
an amplifier having a reference input, a feedback input, and an amplifier output, the feedback input coupled to the power output;
a buffer having a buffer input, a bias input, and a buffer output, the buffer input coupled to the amplifier output;
a level shifter having a level shifter input and a level shifter output, the level shifter input coupled to buffer output, and the level shifter output coupled to the transistor control input;
a first biasing circuit coupled between the power input and the bias input of the buffer; and
a second biasing circuit coupled to the level shifter output and the transistor control input.

23. The apparatus of claim 22, further comprising a voltage boost circuit coupled to the power input and including a boost voltage output, wherein the second biasing circuit is coupled between the boost voltage output and the transistor control input.
